(19) United States
(12) Patent Application Publication
(10) Pub. No.: US 2005/0289639 A1
(43) Pub. Date: Dec. 29, 2005

(54) System and method of securing the management of documentation

(76) Inventor: Wai Kai Leung, Houston, TX (US)

Correspondence Address: Delphine M. James;Attorney-at-Law, Suite 170, 2656 South Loop West, Houston, TX, 77054, US

(21) Appl. No.: 10/874,778

(22) Filed: Jun. 23, 2004

(51) Int. Cl. H04L 9/00

(52) U.S. Cl. 726/2

(57) ABSTRACT

The present invention provides an integrated method and system implemented on a plurality of computer systems in a network. The method is for securing and controlling access to digitized files utilized in the documentation management process. The method further comprises generating a project encryption key for an identified project having a plurality of project documents as well as controlling access to the project encryption key and the plurality of project documents of the identified project to authenticated users. Then, for a selected project document of an authenticated user, an encrypted digitized document is generated utilizing the project encryption key. For a selected project document of an authenticated user, an encrypted text from the selected encrypted graphic image is generated utilizing the project encryption key. For a selected project document of an authenticated user, an encrypted searchable PDF from the selected encrypted PDF is generated utilizing the project encryption key. For a selected project document of an authenticated user, coding instructions is performed on the encrypted digitized file utilizing the project encryption key. Coding instructions can be performed manually or programmatically. For a selected project document of an authenticated user, print (blowback) the encrypted PDF or image utilizing the project encryption key. In some embodiments, a project encryption key is not generated but accepted and stored within the system. Additionally, the system and method is adapted to handle the offsite or offshore coding process.

### BACKGROUND

This invention relates to systems and methods of securely managing documents over a computer network such as a LAN, WAN, or the Internet. Today there are many businesses that require an innovative, efficient, and cost-effective approach to managing voluminous amount of information, for example litigation, government, medicine, and accounting. The single most important challenge is creating, handling, storing, analyzing, and tracking the volume of information. Once stored locating an important document for review among thousand of documents produced is an enormous problem. More importantly, it is important to secure the access of that one important document from compromise. There are traditional encryption security methods available for protecting information from compromise. However, there is a need to secure the access during each stage of the documentation management process over a computer network. When a portion of the documentation management process is performed outside of the United States over the Internet, security becomes imperative.

### SUMMARY

The invention described herein is a method, system and computer product that encrypts and decrypts scanned digital or graphic images (i.e. TIFF, JPG, or any other type of graphic image), Portable Document Format (PDF) or Optical Character Recognition (OCR) text to allow only the authorized users access to the graphic image, PDF and text at all times during the documentation management process. A project manager controls access to the graphic images, PDF and texts on a need-to-know basis by authenticated users. The system includes the following components:
An encryption software driver
A decryption API (Application Program Interface)
A project management system (PMS) which creates a project encryption key which is assigned to a particular project; the PMS stores the project encryption key and controls access to users authorized to perform certain documentation management tasks
Creation of graphic images or PDF from paper, microfilm, microfiche, microfilm, or electronic files;
Conversion of electronic files from one file format to other file format
Verification of created graphic images or PDF
Conversion of the graphic images to OCR text
Conversion of PDF to searchable PDF
Automatic (Programmatic) Coding or Indexing of OCR text
Manual Coding or Indexing of Digitized Document
Documentation Management System to allow clients to manage digitized files
Print (blowback) graphic images or PDF
   The system encrypts files from creation and the files remain encrypted throughout the life span of the project on the system. Secured access is also controlled over a computer network such as a LAN, WAN, or the Internet.

The forgoing and other features and advantages of the invention will be apparent from the following, more particular description of a preferred embodiment of the invention, as illustrated in the accompanying drawings.

### BRIEF DESCRIPTION OF THE DRAWINGS

FIG. 1 illustrates a block diagram of the operational view of the system

FIG. 2 is a flow chart of the PMS administration process of the system.

FIG. 3-3.2 is a flow chart of the encryption driver program of the system.

FIG. 4-4.1 is a flow chart of the physical scanning component of the system.

FIG. 5-5.1 is a-flow chart of the electronic files conversion process of the system.

FIG. 6-6.2 is a flow chart of the OCR conversion process of the system.

FIG. 7-7.2 is a flow chart of the quality control process of the system.

FIG. 8-8.2 is a flow chart of manual coding process of the system.

FIG. 9-9.2 is a flow chart of the automatic indexing process of the system.

FIG. 10-10.2 is a flow chart of the documentation management process of the system.

FIG. 11-11.2 is a flow chart of the offsite or offshore coding process of the system.

FIG. 12-12.2 is a flow chart of the searchable PDF conversion process of the system.

FIG. 13-13.2 is a flow chart of the print (blowback) image or PDF process of the system.

### DETAIL DESCRIPTIONS

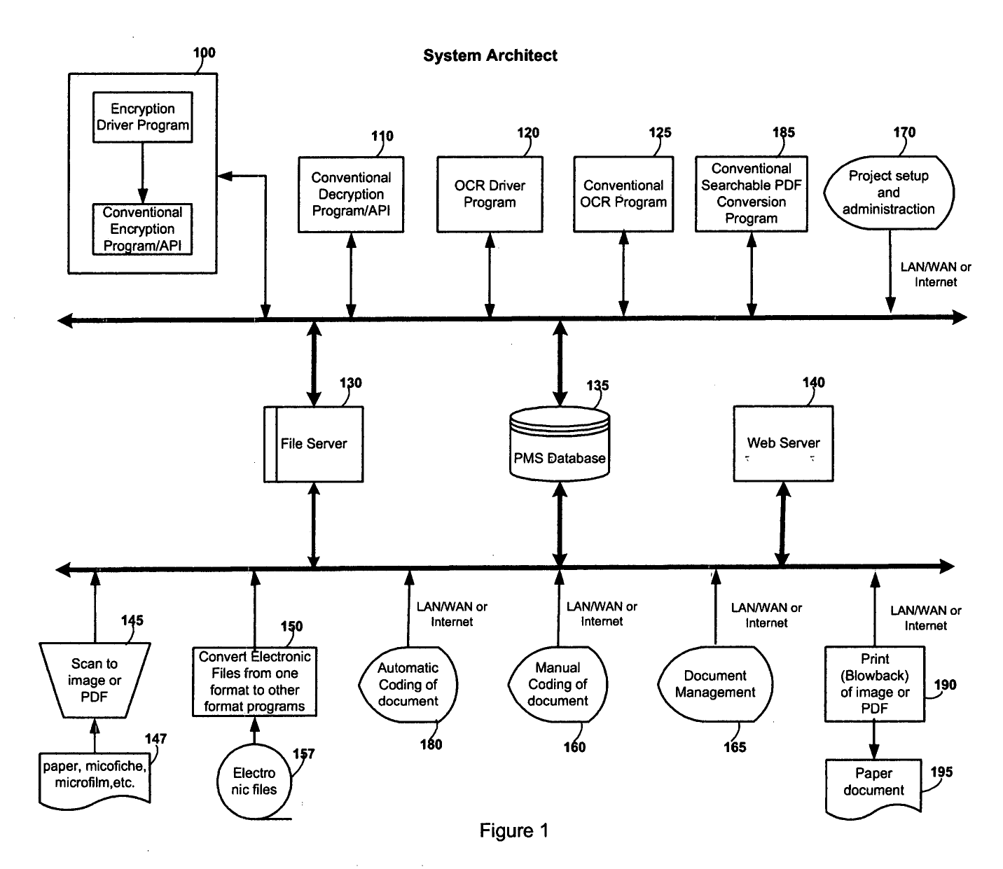

Referring to FIG. 1, there is shown a block diagram of the overall components implementing the system for securely managing voluminous amount of information over a computer network.

The main components of the system are:

Encryption Driver (100)
Decryption API (110)
OCR Driver (120)
Conventional OCR Program (125)
Conventional Searchable PDF Conversion Program (185)
Scanner Component (145)
Electronic File Conversion Component (150)
Automatic (Programmatic) Indexing Component (180)
Manual Coding Component (160)
Document Management Component (165)
Project Administration Component (170)
File Server (130)
Web Server (140)
Project Management Database (135)
Print (Blowback) Image or PDF (190)

Each of the above components is described in detail below.

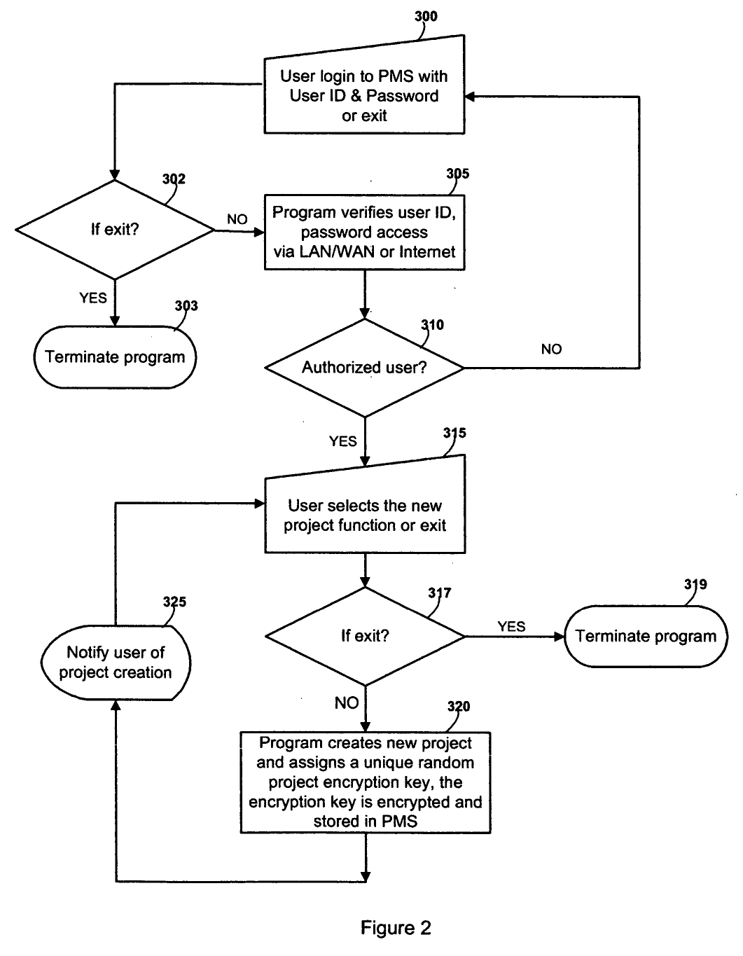

Referring to FIG. 2, there is shown a flow diagram of the project administration component. At step 300 a user logons to the PMS with a user ID and password or exit. At step 302, if the user selects to exit, the system proceeds to step 303 to terminate the program. If at step 302, the user selects to login, the system proceeds to step 305. At step 305, the system verifies the user ID and password and proceeds to step 310. At step 310, if the user is authorized, the system proceeds to step 315. At step 315 the user selects the function of creating a new project or exit. At step 317, if the user selects to exit, the system then proceeds to step 319 to terminate the program. At step 317, if the user selects a new project function the system proceeds to step 320.

At step 320, a new project is created with a project number and a unique random project encryption key. The project encryption key can be encrypted and stored in the Project Management Database. Additionally, applicable tasks for the project are also assigned for example, document scanning, electronic conversion, quality control of PDF or graphic image, document indexing, and other appropriate tasks. Access to the PMS can be via a LAN/WAN or the Internet.

Upon completion of step 320, the system notifies the user that a new project is created at step 325. The system proceeds to step 315, which allows the user to repetitively create new projects until completed.

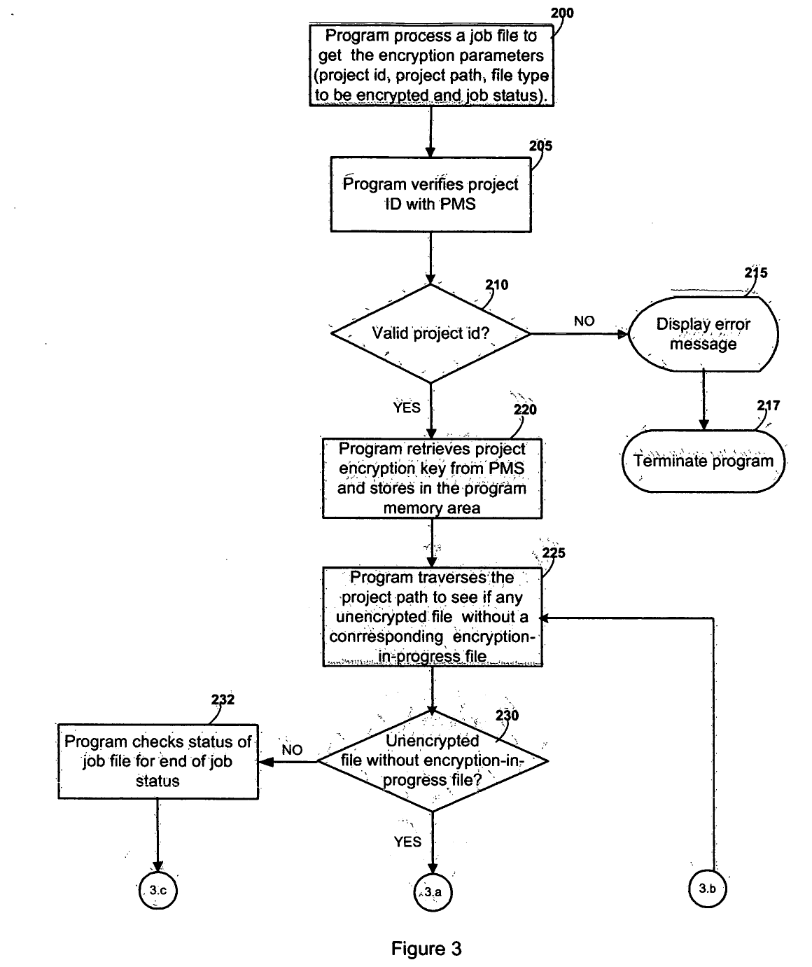

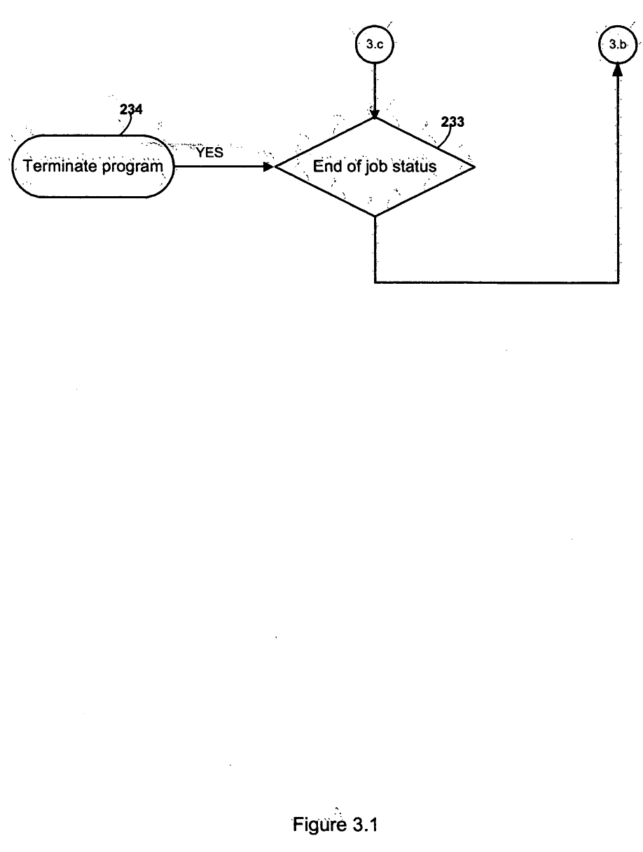

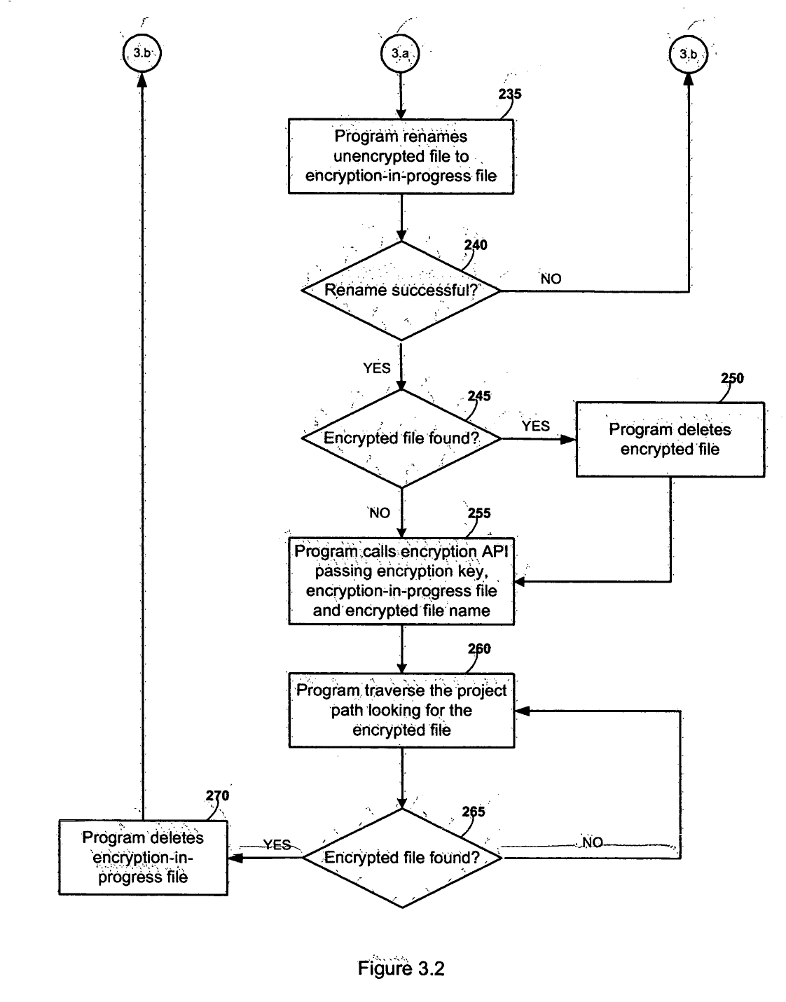

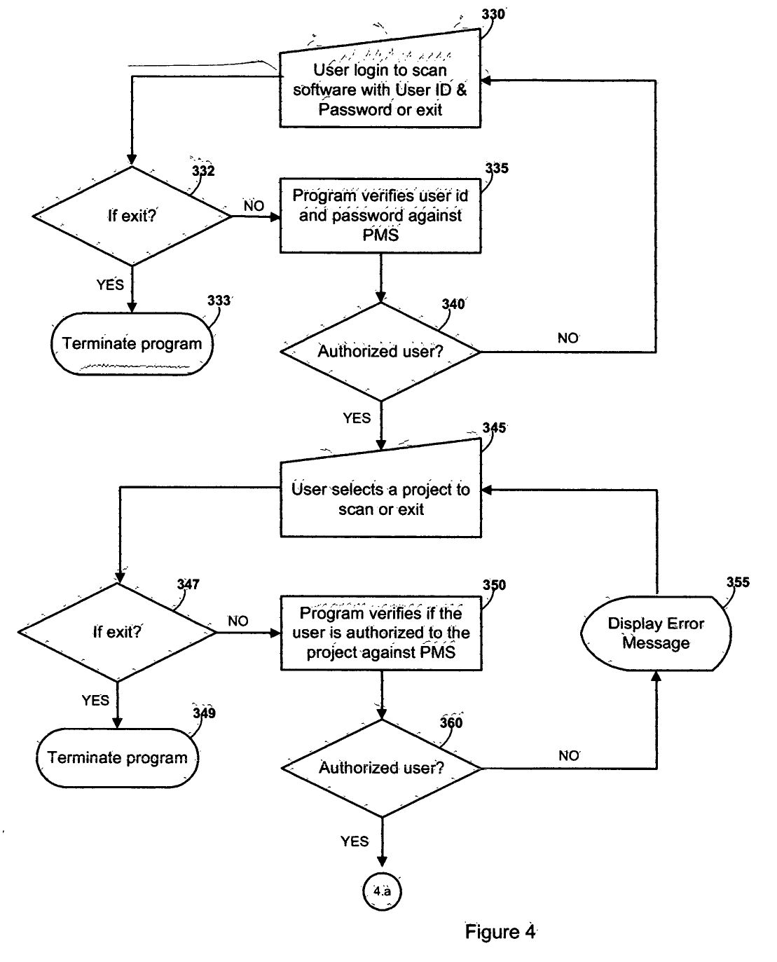

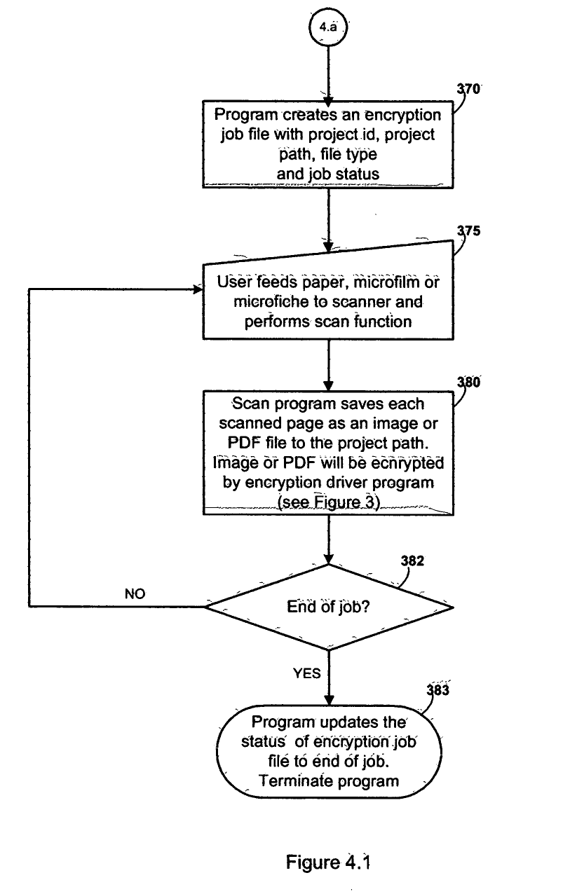

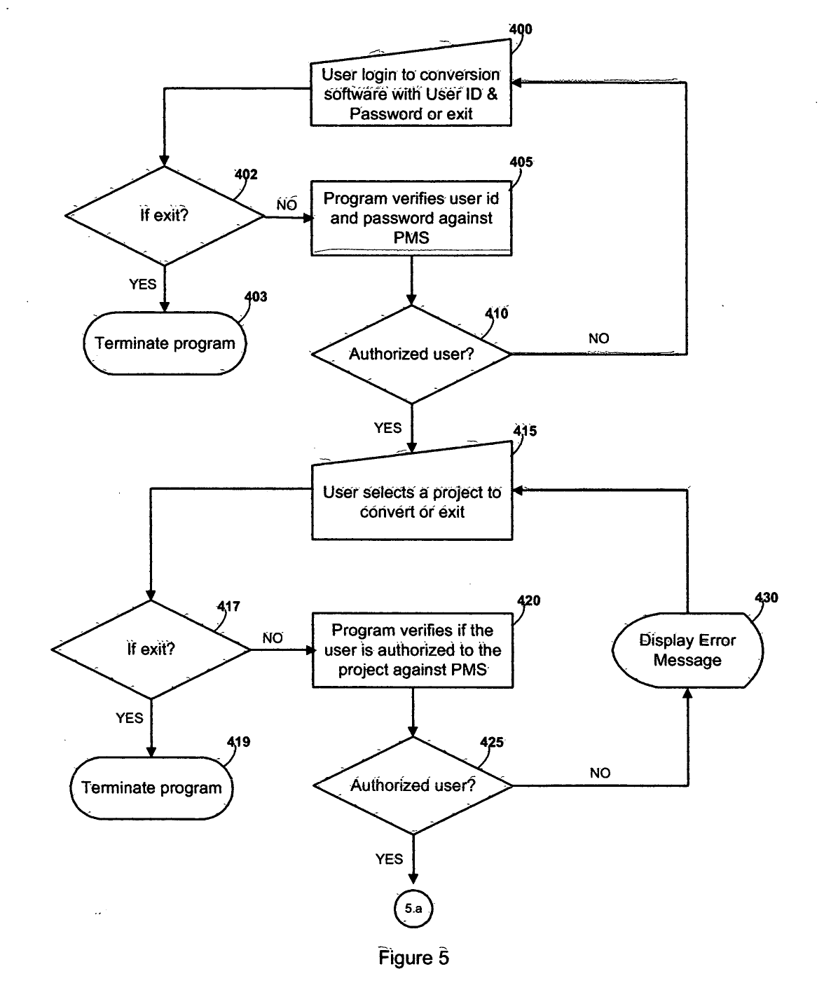

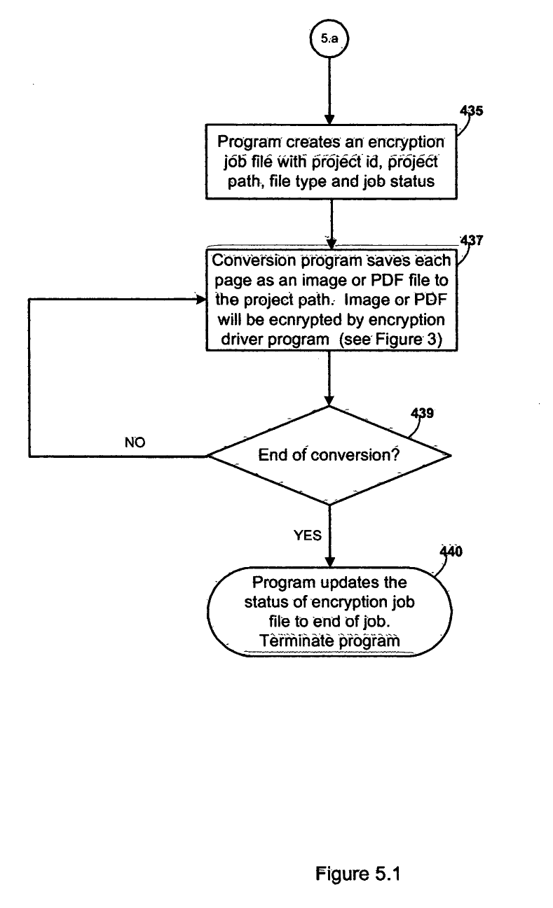

Referring to FIGS. 3, 3.1 and 3.2, there is shown a flow diagram of the encryption driver program. At step 200 the system accesses a job file to get the encryption parameters for a project. The encryption parameters can include a project id, project path, file type(s) to be encrypted and job status. At step 205 the system verifies the project id with the PMS. At step 210 if the project id is invalid, the system proceeds to step 215 to display an error message and then proceeds to step 217 to terminate the program. However, if the project id is valid the system proceeds to step 220 to retrieve the project encryption key from PMS and stores the project encryption key in program memory area for use. At step 225 the system traverses the project path for any unencrypted file that needs to be encrypted, i.e. an unencrypted file without a corresponding encryption-in-progress file. For example, 0001 .tif can have 0001.tif.eip as its encryption-in-progress file. At step 230, if there is no unencrypted file that needs to be encrypted then the system proceeds to step 232. At step 232, the system checks the job status of the job file and proceeds to step 233. At step 233, if end of job status is found, the system proceeds to step 234 to terminate the program. At step 233, if the job status is not equal to end of job, the system loops back to 225. At step-230, if an unencrypted file without a corresponding encryption-in-progress file is found the system proceeds to step 235.

At step 235, the system renames the unencrypted file as encryption-in-progress file (e.g. 0001.tif can be renamed to 0001.tif.eip) and proceeds to step 240. At step 240 if the renaming of the file is not successful (i.e. the file is currently using by other program and it is not ready to be encrypted), the driver program returns to step 225. At step 240, if the file is renamed successfully, the system proceeds to step 245. At step 245, if the encrypted file exists, system proceeds to step 250 to delete the encrypted file and then proceeds to step 255. At step 245, if the encrypted file does not exist, the system proceeds to step 255. At step 255, the system calls the encryption API providing the encryption key, encryption-in-progress file and encrypted file name for encryption and proceeds to step 260. At step 260 the system monitors the project file path for the encrypted file. At step 265, if the encrypted file is found the system proceeds to step 270. At step 270, the system deletes the encryption-in-progress file and then loops back to step. 225 to traverse the project path file for other file to encrypt.

Referring to FIGS. 4 and 4.1, there is shown a flow diagram of the scanning component of the present invention. At step 330 a user logons to the PMS with a user ID and password or exit. At step 332, if the user selects to exit the system, the system proceeds to step 333 to terminate the program. At step 332, if the user selects to login, the system proceeds to step 335. At step 335, the system verifies the user ID and password. At step 340, if the user is not authorized, the system returns back to step 330.

At step 340, if the user is authorized, the system proceeds to step 345. At step 345 the user selects a project to scan or exit and proceeds to step 347. At step 347, if the user selects to exit, the system then proceeds to step 349 to terminate the program. At step 347, if the user selects a project to scan, the system proceeds to step 350. At step 350 the system verifies that the user is authorized to perform the selected project and proceeds to step 360. At step 360, if the user is not authorized, the system proceeds to step 355 to display an error message and then returns to step 345 to select a project to scan or exit. At step 360, if the user is authorized, the system proceeds to step 370. At step 370, the system creates an encryption job file with the project id, project file path name, the file type to encrypt and job status. The job file is created for monitoring by the encryption driver program. At step 375, the user feeds the physical document to scan. At step 380, the scanner program scans each page of the physical document and saves as an image or PDF file into the project path. The encryption driver monitors the project path for unencrypted image or PDF. When the encryption driver detects the unencrypted file, the encryption driver proceeds to encrypt each file. The system proceeds to step 382.

At step 382, the system checks for end of job. If end of job, the system proceeds to step 383 to update the job status of the encryption job file to end of job status and terminate the program. At step 382, if not end of job, the system loops back to step 375.

Referring to FIGS. 5 and 5.1, there is shown a flow diagram of the electronic files (e.g. email, word documents, spreadsheet, image, PDF, etc.) conversion from one format to other format(e.g. image, PDF, text, etc.) component of the present invention. At step 400 a user logons to the PMS with a user ID and password or exit and proceeds to step 402. At step 402, if the user selects to exit, the system proceeds to step 403 to terminate the program. At step 402, if the user selects to login, the system proceeds to step 405. At step 405, the system verifies the user ID and password and proceeds to step 410. If the user is not authorized at step 410 the system returns back to step 400.

If the user is authorized at step 410, the system proceeds to step 415. At step 415 the user selects a project to convert or exit. The system proceeds to step 417. At step 417, if the user selects to exit, the system proceeds to step 419 to terminate the program. At step 417, if the user selects a project to convert, the system proceeds to step 420. At step 420 the system verifies that the user is authorized to perform the selected project and proceeds to step 425. If the user is not authorized at step 425, the system proceeds to step 430 to display an error message and then returns to step 415 to select a project to scan or exit.

If the user is authorized at step 425, the system proceeds to step 435. At step 435, the system creates an encryption job file with the project id, project file path, the file type to encrypt and the job status. The job file is created for monitoring by the encryption driver program. The system then proceeds to step 437. At step 437, the system converts each electronic file to the new electronic file with different format in the project path. The encryption driver monitors the project path for unencrypted file. When the encryption driver detects the unencrypted file, the encryption driver encrypts each unencrypted file. The system proceeds to step 439. At step 439, the system checks for end of conversion. If end of conversion, the system proceeds to step 440. At step 440, the system updates the job status of the encryption job file to end of job and terminates the program.

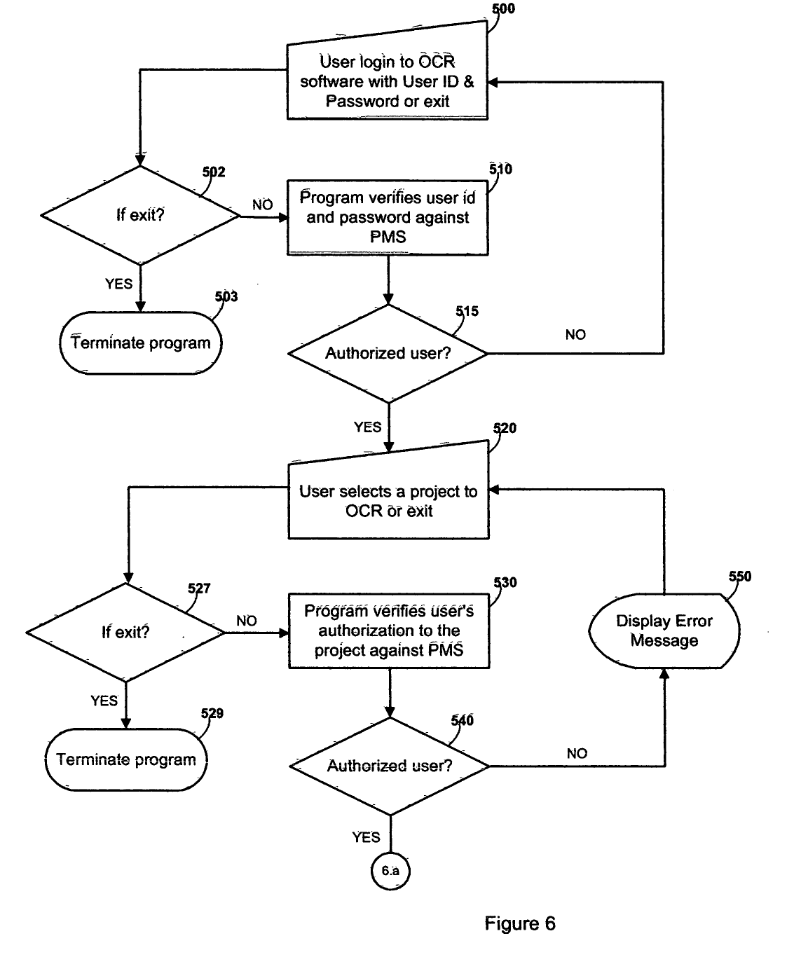

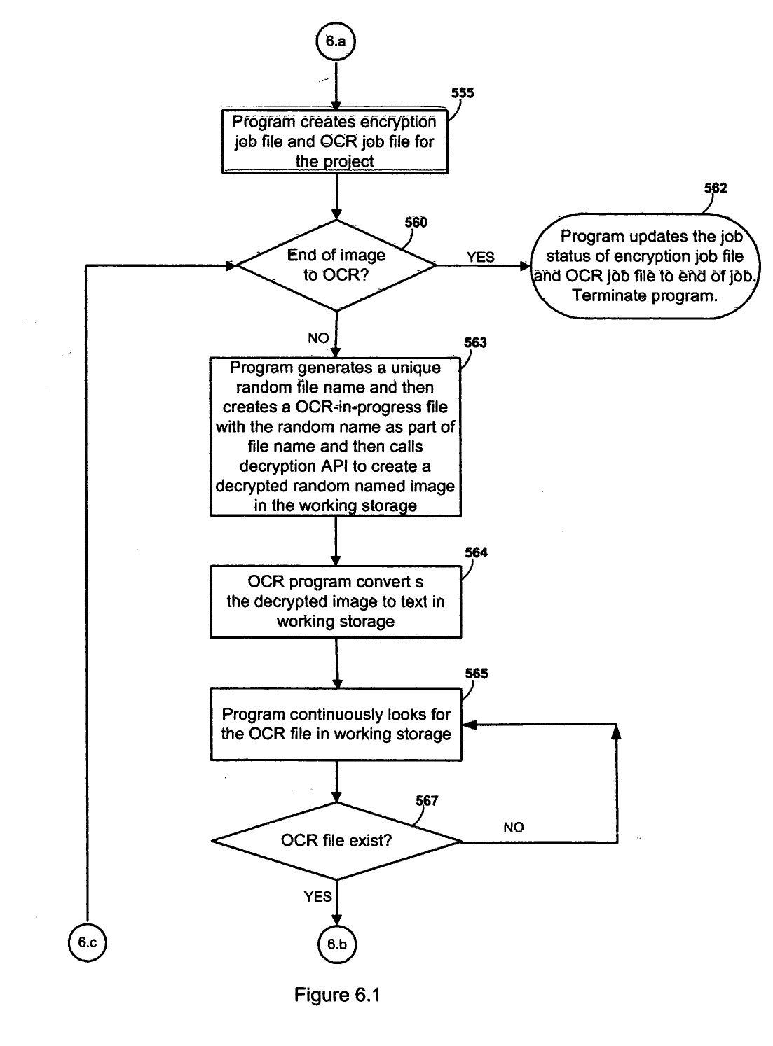

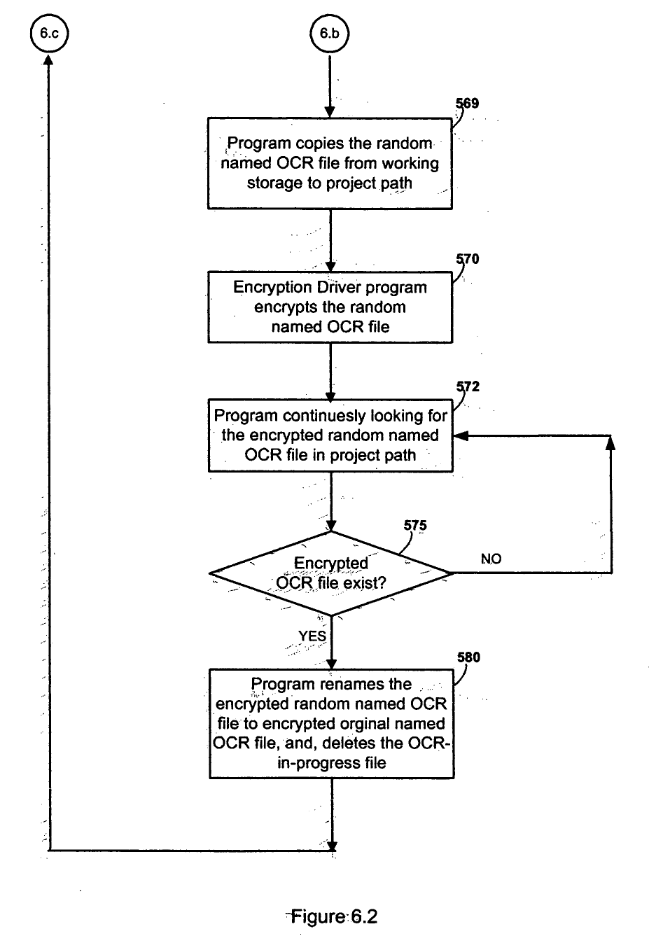

Referring to FIGS. 6, 6.1 and 6.2, there is shown a flow diagram of the OCR conversion component of the present invention. At step 500 a user logons to the PMS with a user ID and password or exit and proceeds to step 502. At step 502, if the user selects to exit, the system proceeds to step 503 to terminate the program. At step 502, if the user selects to login, the system proceeds to step 510. At step 510, the system verifies the user ID and password and proceeds to step 515. At step 515, if the user is not authorized, the system returns to step 500. At step 515, if the user is authorized, the system proceeds to step 520. At step 520 the user selects a project to OCR or exit. The system proceeds to step 527. If at step 527, the user selects to exit, the system proceeds to step 529 to terminate the program. At step 527, if the user selects a project to OCR, the system proceeds to step 530. At step 530 the system verifies that the user is authorized to perform the selected project and proceeds to step 540. If the user is not authorized at step 540, the system proceeds to step 550 to display an error message and then returns to step 520 to select a project to OCR or exit.

If the user is authorized at step 540, the system proceeds to step 555. At step 555, the system creates an encryption job file for the encryption driver program and an OCR job file for the OCR program to convert image to text. At step 560, an end of loop test condition is created. If there are no more images to OCR (i.e. each encrypted image has a corresponding encrypted OCR or an OCR-in-progress file), the system proceeds to step 562. At step 562, the system updates the job status of encryption job file and OCR job file to end of job status. The system then terminates the program. At step 560, if there is an encrypted image to OCR, the system proceeds step 563. At step 563 the system generates a unique random file name and creates an OCR-in-progress file using the encrypted image name and the random file name as the name of the OCR-in-progress file. For example, a random file name ‘abcdz001’ and an encrypted image, 00001.tif.sde will have an OCR-in-progress file named ‘00001.tif sde.abcdz001.oip’. The system then calls the decryption API passing the encryption key, the encrypted image and the random named image file to decrypt the image into the working storage. It then proceeds to step 564. At step 564, the OCR program converts the decrypted image to an unencrypted OCR file in the working storage. At step 565, the system continuously looks for the unencrypted OCR file in the working storage. At step 567, if the unencrypted OCR file exists, the system proceeds to step 569. At step 569, the system copies the unencrypted OCR file from the working storage to the project path and proceeds to step 570. At step 570, the encryption driver program encrypts the unencrypted OCR file and creates an encrypted OCR file. At step 572, the system continuously looks for the encrypted OCR file in the project path and proceeds to step 575. At step 575, if the encrypted OCR file does not exist, the system loops backs to step 572. At step 575, if the encrypted OCR file exists, the system proceeds to step 580. At step 580, the system renames the encrypted random OCR file to the encrypted OCR file name corresponding to its image name (e.g. encrypted image, 00001.tif.sde, can have encrypted OCR, 00001.txt.sde). The system then deletes the OCR-in-progress file and the unencrypted OCR file in project path, the decrypted image and the unencrypted OCR file in the working storage and the system then loops back to step 560 to obtain the next image to OCR.

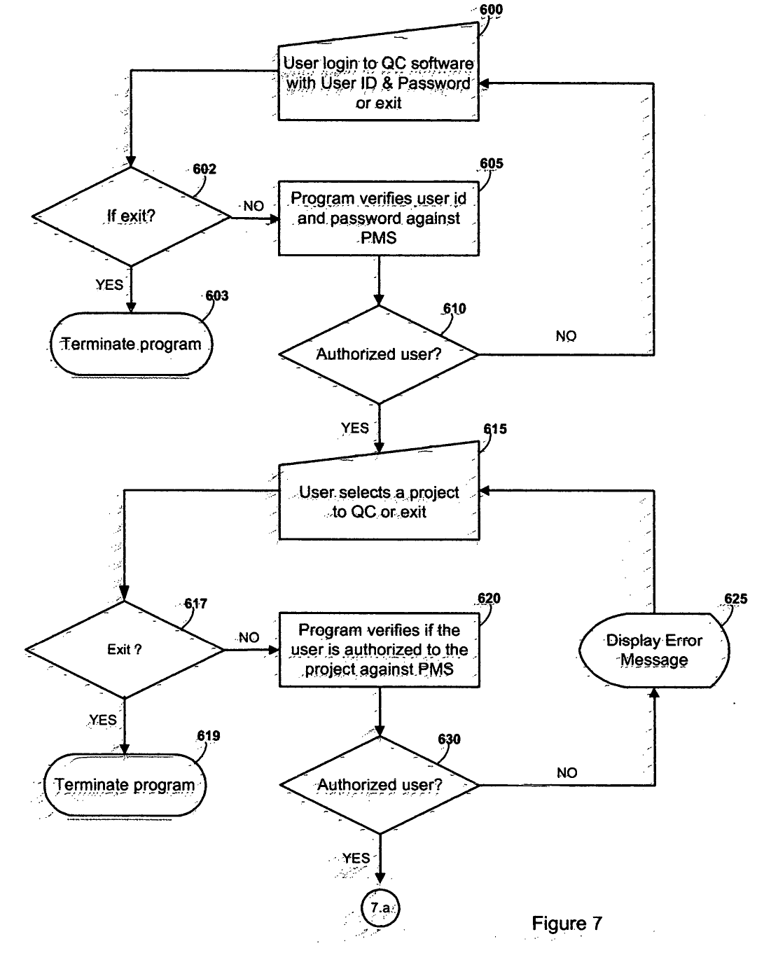

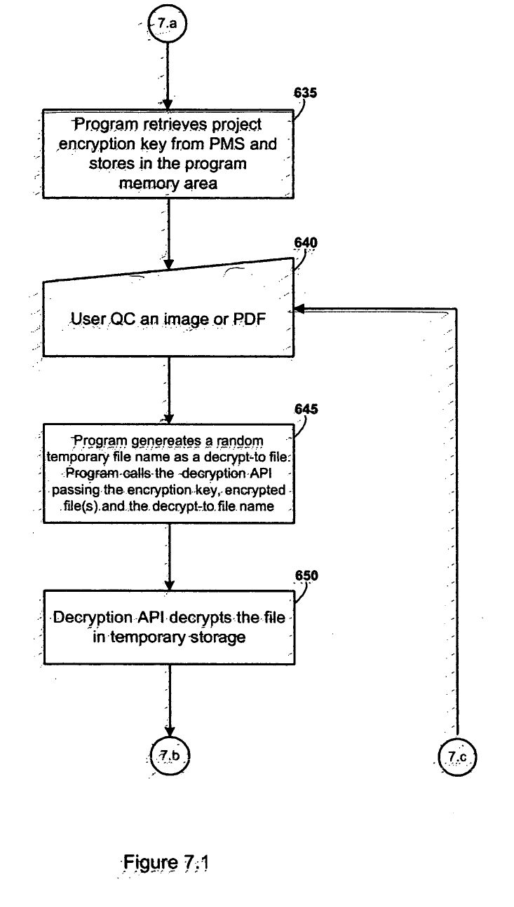

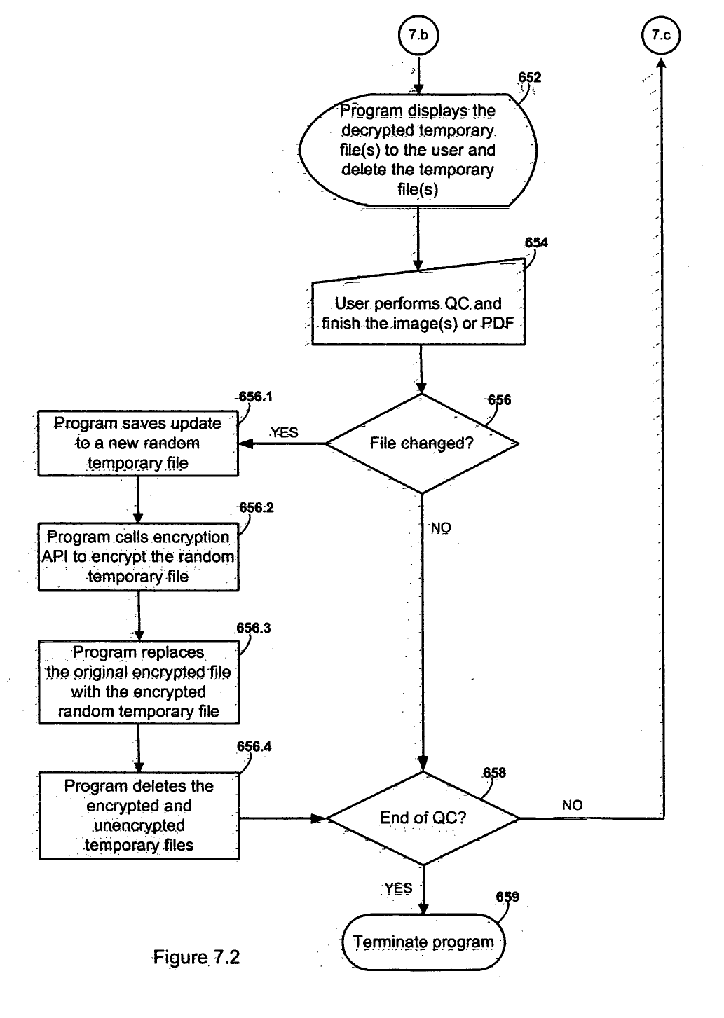

Referring to FIGS. 7, 7.1 and 7.2, there is shown a flow diagram of the QC component of the present invention. At step 600 a user logons to the PMS with a user ID and password or exit. At step 602, if the user selects to exit, the system then proceeds to step 603 to terminate the program. At step 602, if the user selects to login, the system proceeds to step 605. At step 605, the system verifies the user ID and password and proceeds to step 610. At step 610, if the user is not authorized, the system returns back to step 600. At step 610, if the user is authorized, the system proceeds to step 615.

At step 615 the user selects a project to QC or exit. If at step 617, the user selects to exit, the system then proceeds to step 619 to terminate the program. If at step 617, the user selects a project to QC, the system proceeds to step 620. At step 620 the system verifies that the user is authorized to perform the selected project. If the user is not authorized at step 630, the system proceeds to step 625 to display an error message and then returns to step 615 to select a project to QC or exit the function.

If the user is authorized at step 630, the system proceeds to step 635. At step 635, the system retrieves the project encryption key from PMS and stores in the program memory area. At step 640, the user performs quality control on a document file. At step 645, the system generates a unique random temporary file name for each required file and calls the decryption API with the encryption key, the encrypted file and the random temporary file name to decrypt the required file. At step 650, the decryption API decrypts the file and stores the decrypted file in the temporary storage. At step 652, the system displays the decrypted file to the user and deletes the decrypted file from the temporary storage. At step 654, the user performs QC on the decrypted file. At step 656, if the user enters any changes to the document file, then a new encrypted file needs to be created. At step 656.1, the system saves the updated document file to anew random temporary file in the temporary storage. At step 656.2, the system calls the encryption API with the project encryption key to encrypt the random temporary file. At step 656.3, when the encrypted random temporary file is created, the system replaces the original encrypted document file with the encrypted random temporary file in the project path. At 656.4, the system deletes the unencrypted random temporary file and the encrypted random temporary file from the temporary storage.

At step 658 the system determines if there are more documents to process. If there is no other document to process, the system proceeds to step 659 to terminate the program. At step 658, if there are other documents to process, the system returns to step 640 where the user can select another document to QC.

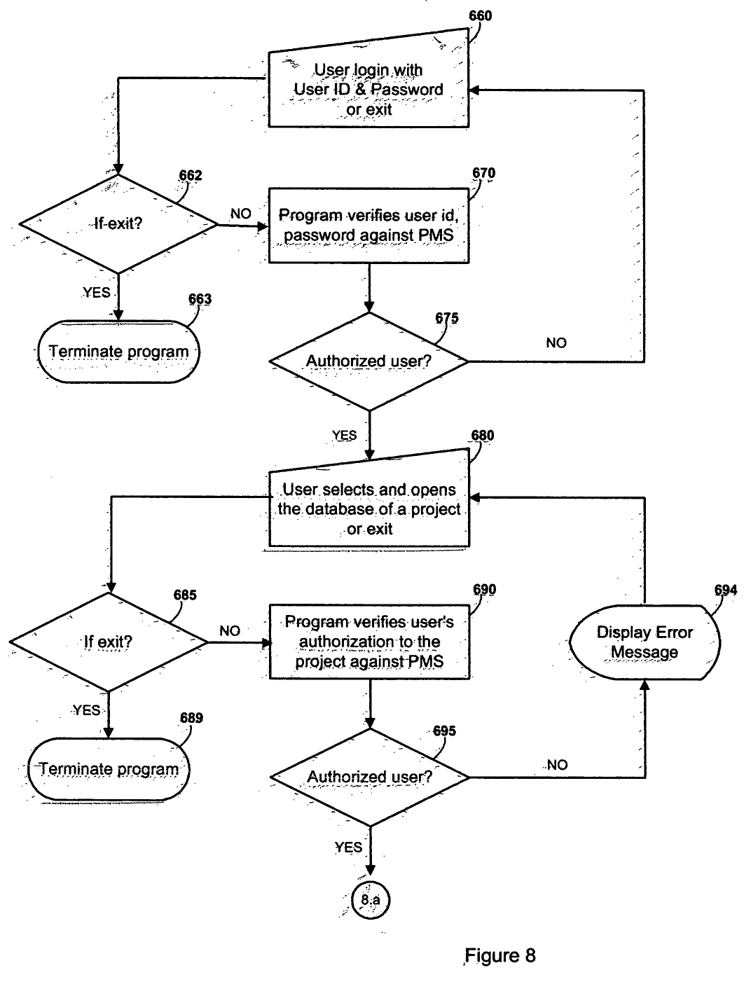

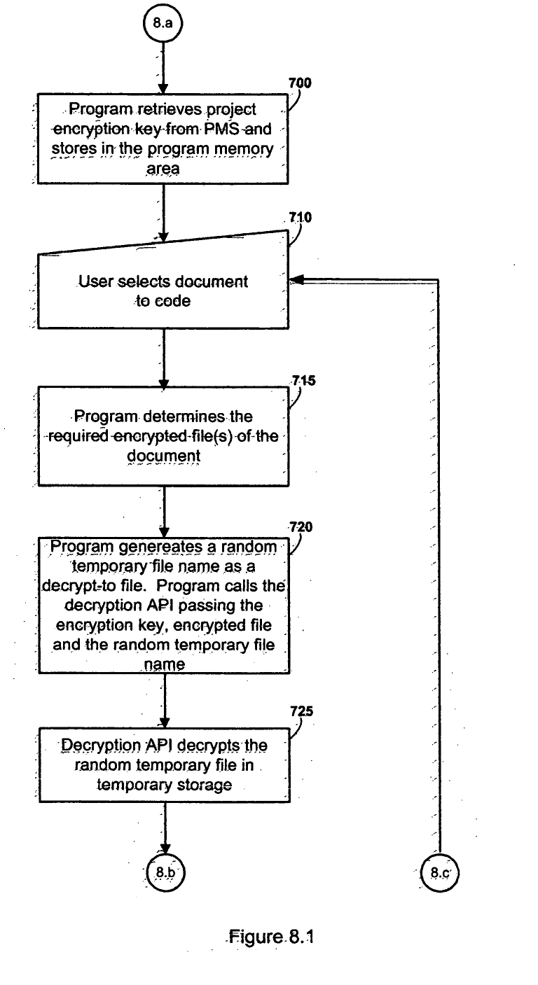

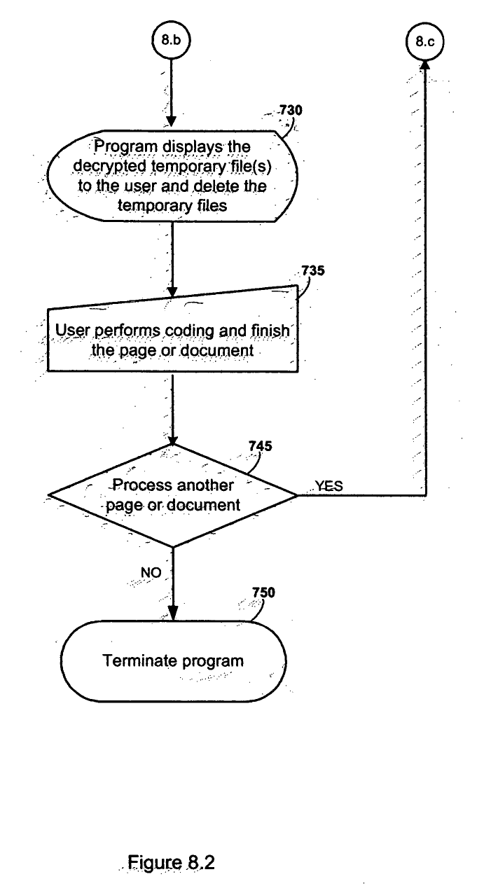

Referring to FIGS. 8, 8.1 and 8.2 there is shown a flow diagram of the Manual Coding component of the present invention. At step 660 a user logons to the PMS with a user ID and password or exit. At step 662, if the user selects to exit, the system then proceeds to step 663 to terminate the program. At step 662, if the user selects to login, the system proceeds to step 670. At step 670, the system verifies the user ID and password and proceeds to step 675. At step 675, if the user is not authorized, the system returns back to step 660. At step 675, if the user is authorized, the system proceeds to step 680.

At step 680 the user selects a project to manually code or exit and proceeds to step 685. At step 685, if the user selects to exit, the system then proceeds to step 689 to terminate the program. At step 685, if the user selects a project to code, the system proceeds to step 690. At step 690 the system verifies that the user is authorized to perform the selected project. At step 695, if the user is not authorized, the system proceeds to step 694 to display an error message and then returns to step 680 to select a project to Manually Code or exit the function.

At step 695, if the user is authorized, the system proceeds to step 700. At step 700, the system retrieves the project encryption key and stores it in the program memory area and proceeds to step 710. At step 710, the user selects a document to manually code. At step 715, the system determines the required encrypted files of the selected document. At step 720 the system generates a random temporary file name for each required encrypted file and then the system calls the decryption API with the project , encryption key, the encrypted file and the random temporary file to decrypt the document file. At step 725, the decryption API decrypts the document file and stores in the temporary storage. At step 730, the system displays the decrypted document file to the user and deleted the decrypted document file from the temporary storage. At step 735, the user performs manual coding on the decrypted file. A step 745, the system determines if there is another document to process. If there is no other document to process, the system proceeds to step 750 to terminate the program. At step 745, if there are other documents to process, the system returns to step 710 where the user can select another document to manually code.

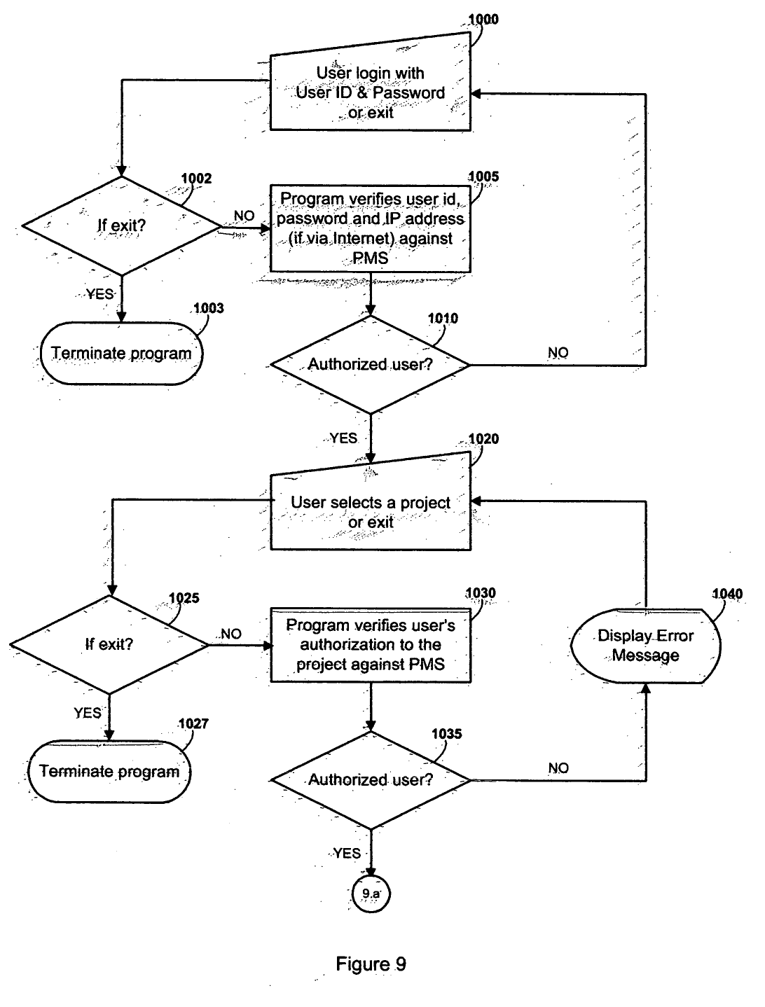

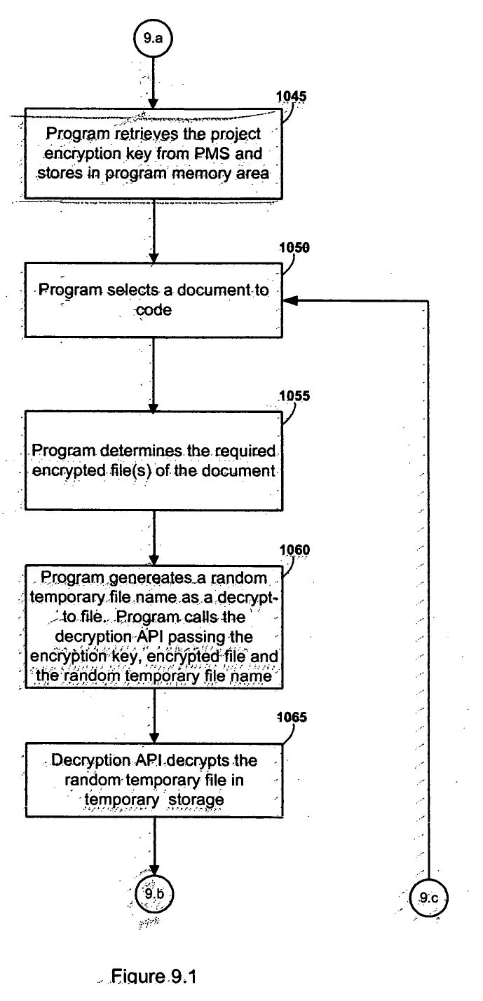

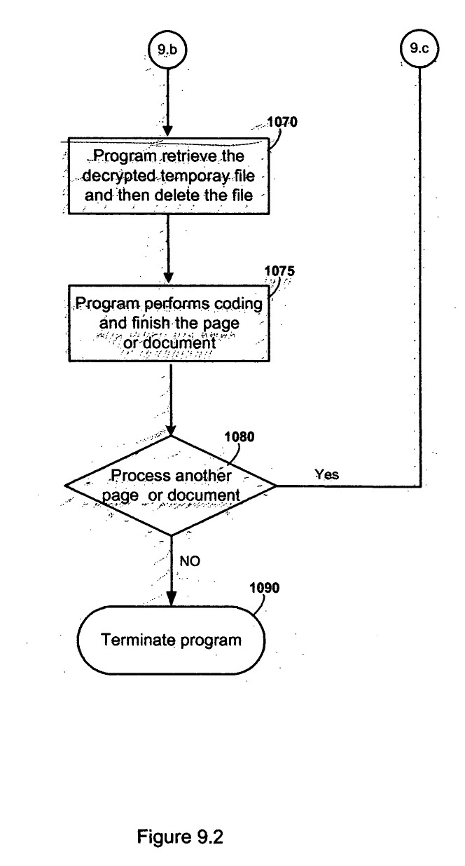

Referring to FIGS. 9, 9.1 and 9.2, there is shown a flow diagram of the Automatic (Programmatic) Coding component of the present invention. At step 1000 a user logons to the PMS with a user ID and password or exit. At step 1002, if the user selects to exit, the system then proceeds to step 1003 to terminate the program. At step 1002, if the user user ID and password and proceeds to step 1010. At step 1010, if the user is not authorized, the system returns back to step 1000. At step 1010, if the user is authorized, the system proceeds to step 1020.

At step 1020 the user selects a project to automatically code or exit and proceeds to step 1025. At step 1025, if the user selects to exit, the system then proceeds to step 1027 to terminate the program. At step 1025, if the user selects a project, the system proceeds to step 1030. At step 1030 the system verifies that the user is authorized to perform the selected project. At step 1035, if the user is not authorized, the system proceeds to step 1040 to display an error message and then to step 1020 to select a project to automatically code or exit the function.

At step 1035, if the user is authorized, the system proceeds to step 1045. At step 1045, the system retrieves the project encryption key from PMS and stores in the program memory area. At step 1050, the system selects a document to automatically code. At step 1055, the system determines the required encrypted files of the selected document. At step 1060 the system generates a random temporary file name for each required encrypted file and then the system calls the decryption API with the project encryption key, the encrypted file and the random temporary file to decrypt the document file. At step 1065, the decrypted document file is stored in temporary storage. At step 1070, the system reads the decrypted document file and deletes the decrypted document file in the temporary storage. At step 1075, the system performs automatic coding on the decrypted document. At step 1080, the system determines if there is another document to process. At step 1080, if there is no other document to process, the system proceeds to step 1090 to terminate the program. At step 1080, if there are other documents to process the system returns to step 1050 to select another document to automatic ally code.

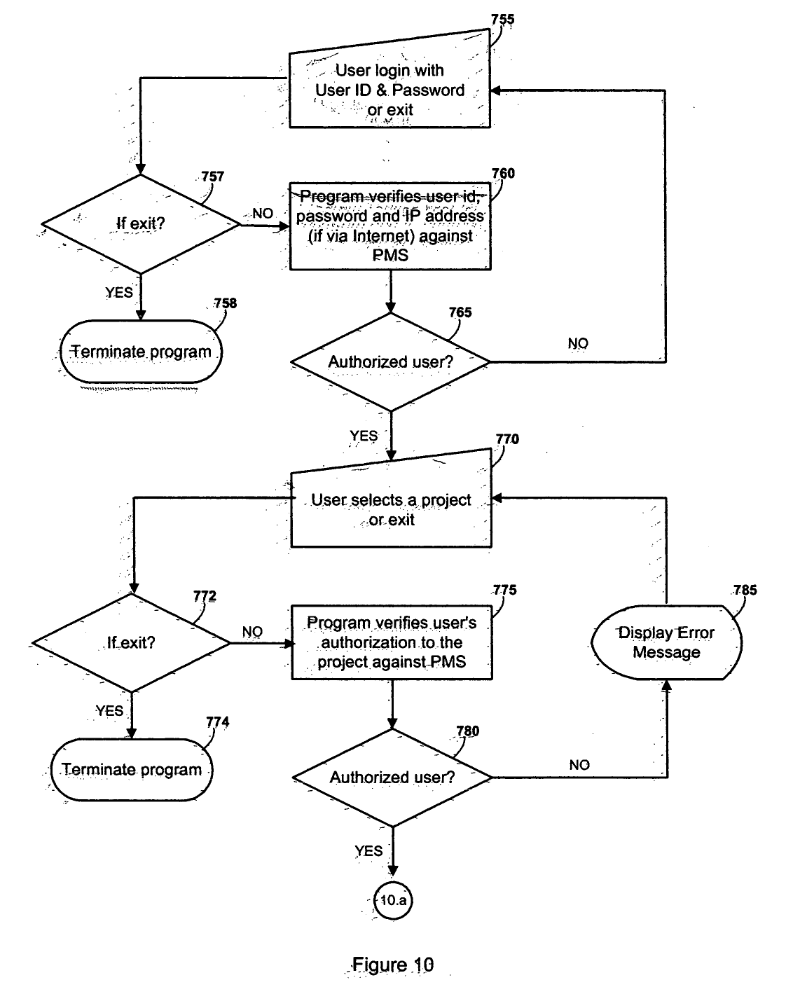

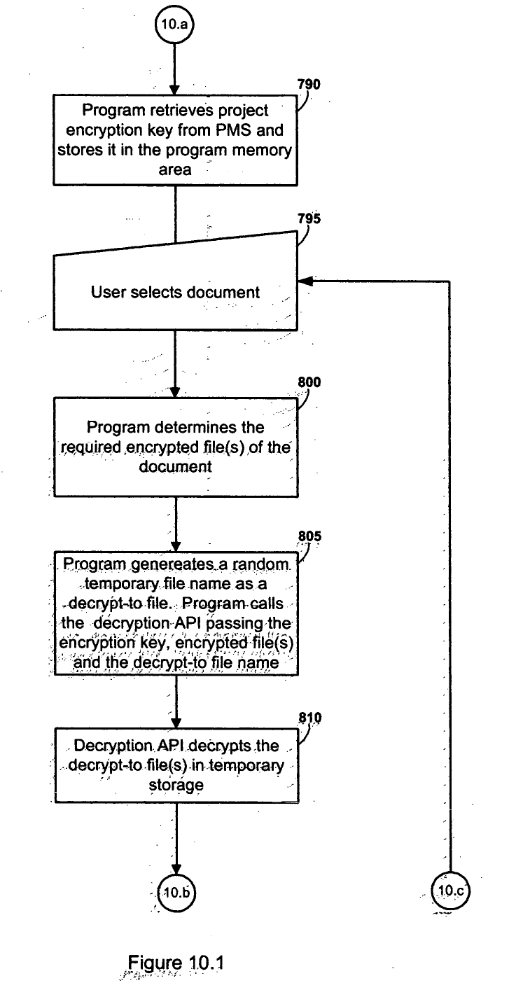

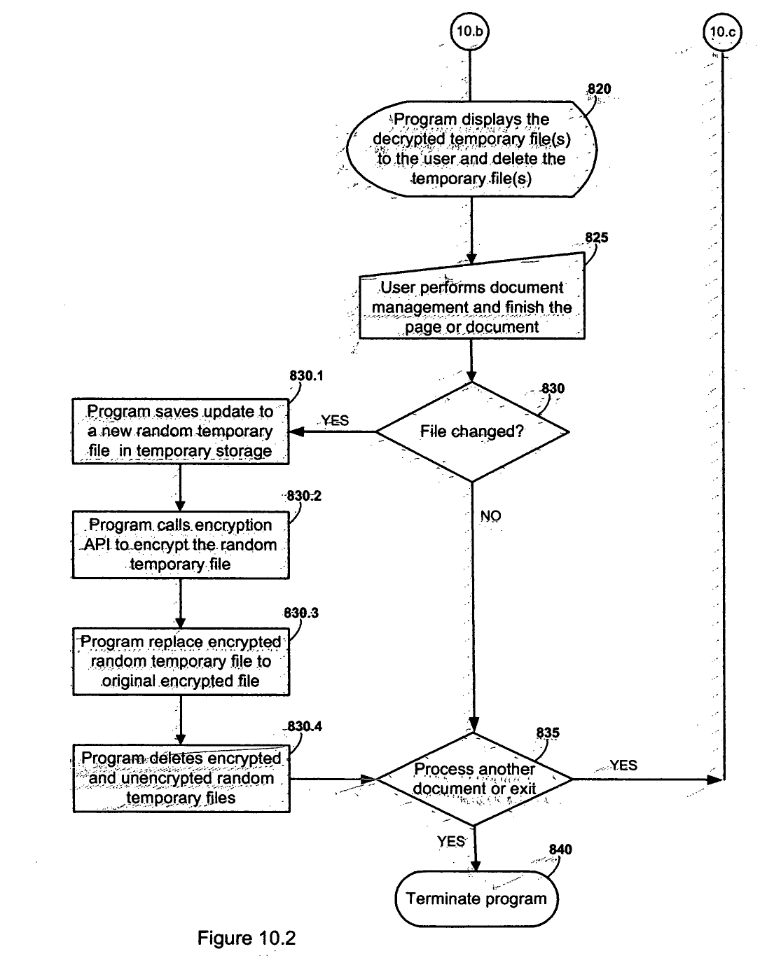

Referring to FIGS. 10, 10.1 and 10.2, there is shown a flow diagram of the Documentation Management Component of the present invention. This component provides tools that allow the user to manipulate the encrypted project files after coding is Performed. Those tools can be standard office tools such as Microsoft Office tools (i.e. excel, access word). At step 755 a user logons to the PMS with a user ID and password or exit. At step 757, if the user selects to exit, the system then proceeds to step 758 to terminate the program. At step 757, if the user selects to login, the system proceeds to step 760. At step 760, the system verifies the user logon, password and IP address, if access via Internet. At step 765, if the user is not authorized, the system returns back to step 755. At step. 765, if the user is authorized, the system proceeds to step 770. At step 770 the user selects a project or exit and proceeds to step 772. At step 772, if the user selects to exit, the system then proceeds to step 774 to terminate the program. At step 772, if the user selects a project, the system proceeds to step 775. At step 775 the system verifies that the user is authorized to perform the selected project. At step 780, if the user is not authorized, the system proceeds to step 785 to display an error message and then returns to step 770 to select another project or exit the function.

At step 780, if the user is authorized, the system proceeds to step 790. At step 790, the system retrieves the project encryption key and stores in the program memory area. At step 795, the user selects a document. At step 800, the system determines the required encrypted files of the selected document. At step 805 the system generates a random temporary file name for each required encrypted file. At step 810, the system calls the decryption API with the project encryption key, the encrypted file and the random temporary file to decrypt the document file. At step 810, decryption API decrypts the document file and stores in the temporary storage. At step 820, the system displays the decrypted document file to the user and deletes the decrypted document file from the temporary storage. At step 825, the user performs documentation management. At step 830, if the user enters any changes to the document file, then a new encrypted file needs to be created. At step 830.1, the system saves the updated document file to a new random temporary file in the temporary storage. At step 830.2, the system calls the encryption API with the project encryption key to encrypt the random temporary file in the temporary storage. At step 830.3, when an encrypted random temporary file is created, the system replaces the original encrypted document file with the encrypted random temporary file. At 830.4, the system deletes the unencrypted random temporary file and the encrypted random temporary file from the temporary storage.

At step 835 the user selects another document to process or exit. If the user selects to exit, the system proceeds to step 840 to terminate the program. At step 835, if the user selects to process another document, the system returns to step 795 where the user can select another document to perform documentation management.

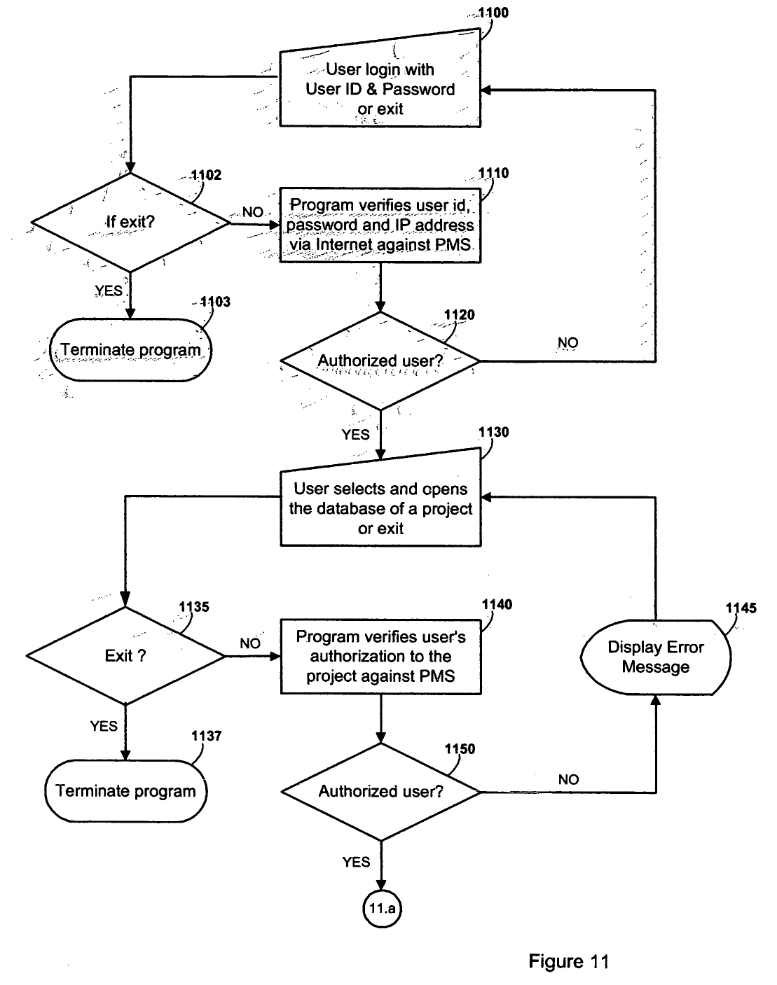

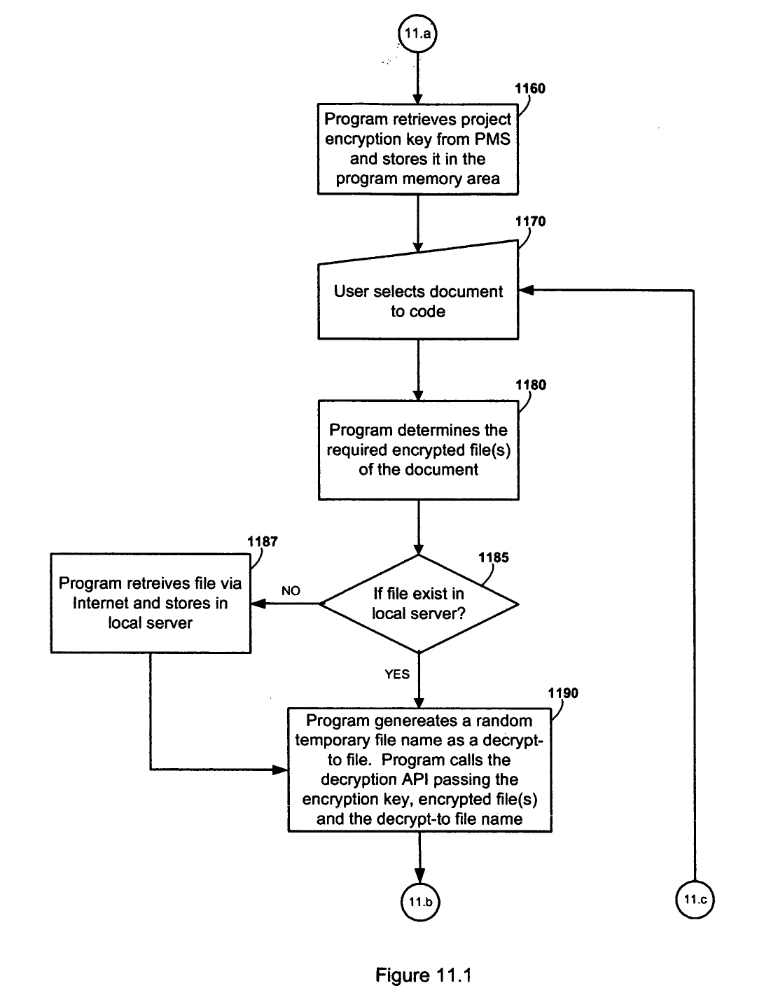

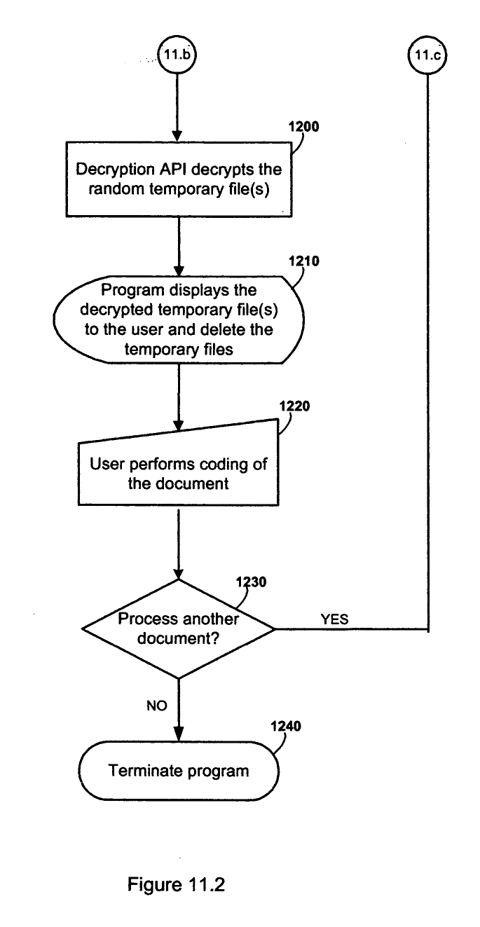

Referring to FIGS. 11, 11.1 and 11.2, there is shown a flow diagram of the offsite or offshore Manual Coding component of the present invention. The image files can be stored in the local server or the web server. If stored in the web server, the selected image file can be transmitted via Internet. At step 1100 a user logons to the PMS with a user ID and password or exit. At step 1102, if the user selects to exit, the system then proceeds to step 1103 to terminate the program. At step 1102, if the user selects to login, the system proceeds to step 1110. At step 1110, the system verifies the user ID and password and proceeds to step 1120. At step 1120, if the user is not authorized, the system returns back to step 1100.

At step 1120, if the user is authorized, the system proceeds to step 1130. At step 1130 the user selects a project to manually code or exit. At steps 1135, if the user selects to exit, the system then proceeds to step 1137 to terminate the program. At step 1135, if the user selects a project, the system proceeds to step 1140. At step 1140 the system verifies that the user is authorized to perform the selected project. At step 1150, if the user is not authorized, the system proceeds to step 1145 to display an error message and then returns to step 1130 to select a project to Manually Code or exit the function.

At step 1150, if the user is authorized, the system proceeds to step 1160. At step 1160, the system retrieves the project encryption key and stores in the program memory area. At step 1170, the user selects a document to manually code. At step 1180, the system determines the required encrypted files of the selected document. At step 1185, the system checks if the required encrypted files exist in the local file server. If the files exist, the system proceeds to step 1190. If a file does not exist, the system proceeds to step 1187. At step 1187, the system calls the file retrieval function to retrieve the file 18. from the web site and stores it in the local file server. The system then proceeds to step 1190. At step 1190 the system generates a random temporary file name for each required encrypted file and the system then calls the decryption API with the project encryption key, the encrypted file and the random temporary file to decry the document file. At step 1200, decryption API decrypts the file to the random temporary file and stores in the temporary storage. At step 1210, the system displays the decrypted random temporary file to the user and deletes the decrypted random temporary file from the temporary storage. At step 1220, the user performs manual coding. At step 1230 the system determines if there is another document to process. If there is no other document to process, the system terminates at step 1240. However, if there are other documents to process the system returns to step 1170 where the user can select another document to manually code.

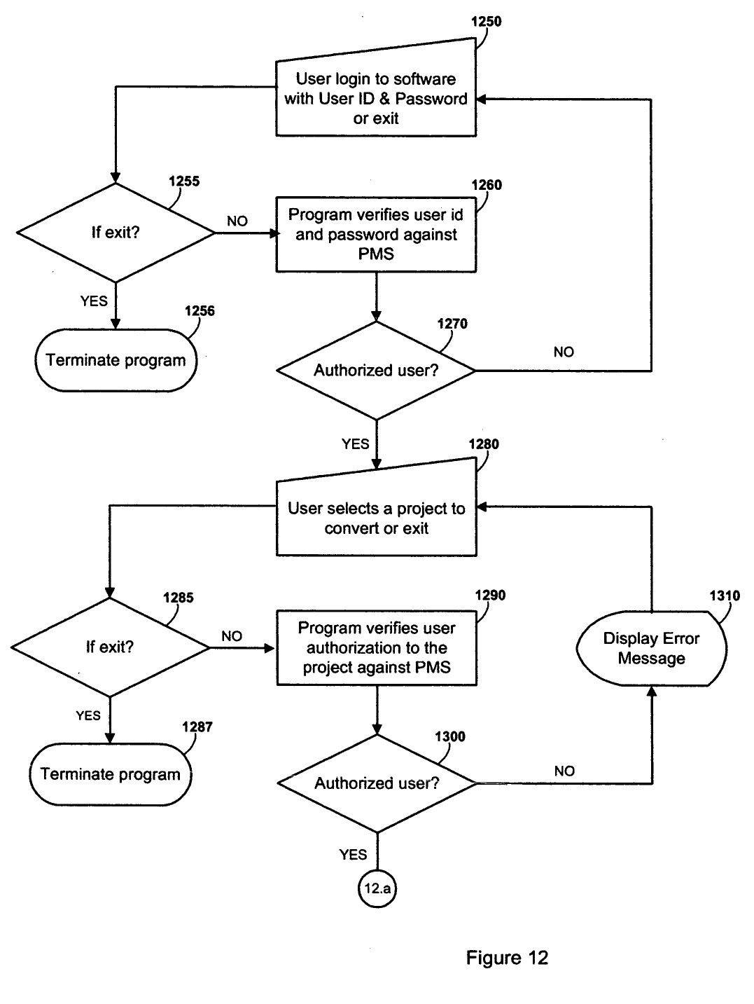

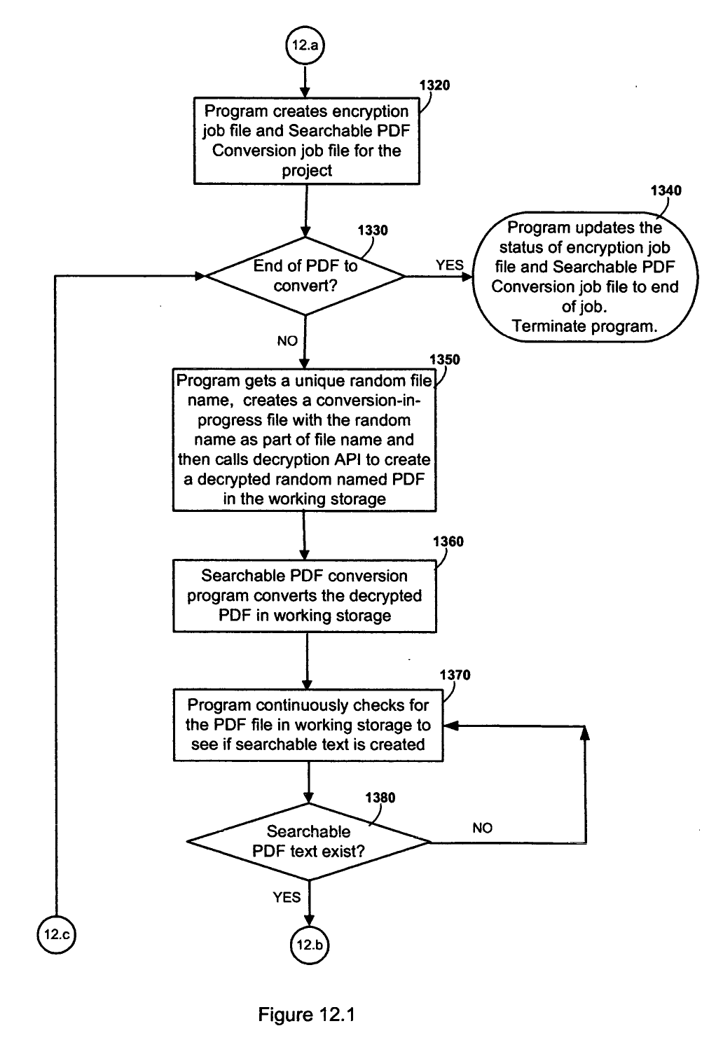

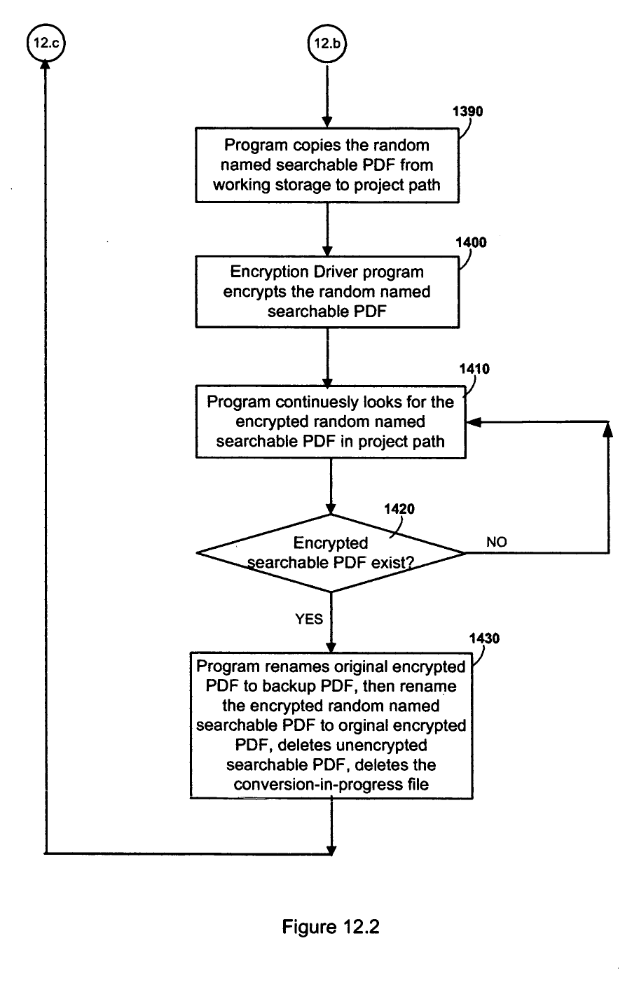

Referring to FIGS. 12, 12.1 and 12.2, there is shown a flow diagram of the Searchable PDF Conversion component of the present invention. At step 1250, a user logons to the PMS with a user ID and password or exit and proceeds to step 1255. At step 1255, if the user selects to exit, the system proceeds to step, 1256 to terminate the program. At step 1255, if the user selects to login, the system proceeds to step 1260. At step 1260, the system verifies the user ID and password and proceeds to step 1270. At step 1270, if the user is not authorized, the system returns back to step 1250. At step 1270, if the user is authorized, the system proceeds to step 1280.

At step 1280 the user selects a project to convert or exit. The system proceeds to step 1285. At step 1285, if the user selects to exit, the system proceeds to step 1287 to terminate the program. At step 1285, if the user selects a project, the system proceeds to step 1290. At step 1290 the system verifies that the user is authorized to perform the selected project. At step 1300, if the user is not authorized, the system proceeds to step 1310 to display an error message and then returns to step 1280 to select a project to convert or exit. At step 1300, if the user is authorized, the system proceeds to step 1320. At step 1320, the system creates an encryption job file for the encryption driver program and a Searchable PDF Conversion job file for the conversion program to create searchable text for PDF. At step 1330, an end of loop test condition is created. If there is no more PDF to convert, the system proceeds to step 1340. At step 1340, the system updates the job status of encryption job file and Searchable PDF Conversion job file to end of job status. The system then terminates the program. At step 1330, if there is an encrypted PDF to convert, the system proceeds to step 1350. At step 1350, the system generates a unique random file name and creates a conversion-in-progress file using the encrypted PDF name and the random file name as the name of the conversion-in-progress file. For example, a random file name ‘abcdz090’ and an encrypted PDF, 00001.pdf.sde, can have a conversion-in-progress file named ‘00001.pdf.sde.abcdz090.cip’. The system then calls the decryption API passing the encrypting key, the encrypted PDF. and random named PDF file name to create a decrypted PDF in the working storage. It then proceeds to step 1360. At step 1360, Searchable PDF Conversion program creates searchable text in the unencrypted random named PDF file in the working storage. At step 1370, the system continuously checks the decrypted random named PDF file in the working storage to see if searchable text is created. At step 1380, if the searchable text is created, the system proceeds to step 1390. At step 1390, the system copies the unencrypted random named PDF file from the working storage to the project path and proceeds to step 1400. At step 1400, the encryption driver program encrypts the unencrypted random named PDF file and creates an encrypted random named PDF file. At step 1410, the system continuously looks for the encrypted random named file in the project path. At step 1420, if the encrypted random named file does not exist, the system loops backs to step 1410. At step 1420, if the encrypted random named file exists, the system proceeds to step 1430. At step 1430, the system renames the original encrypted PDF to a backup PDF and the system then renames the encrypted random named PDF file to the encrypted original PDF file name. The System the deletes the unencrypted random named file and the conversion-in-progress file from the working storage and loops back to step 1330 to process the next PDF.

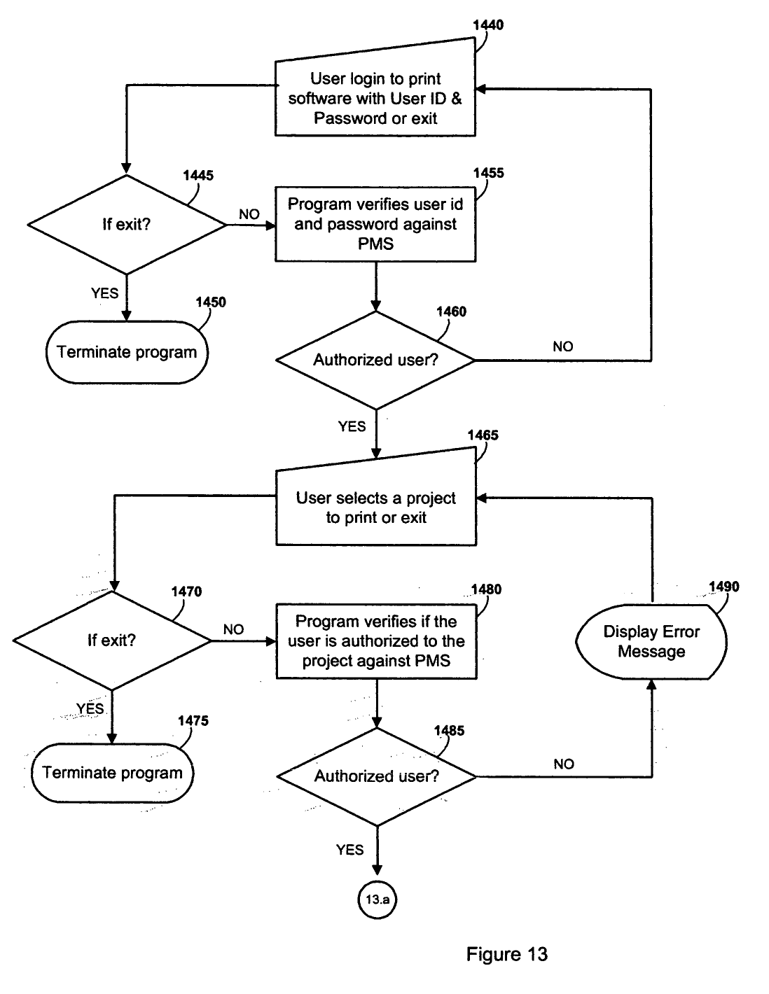

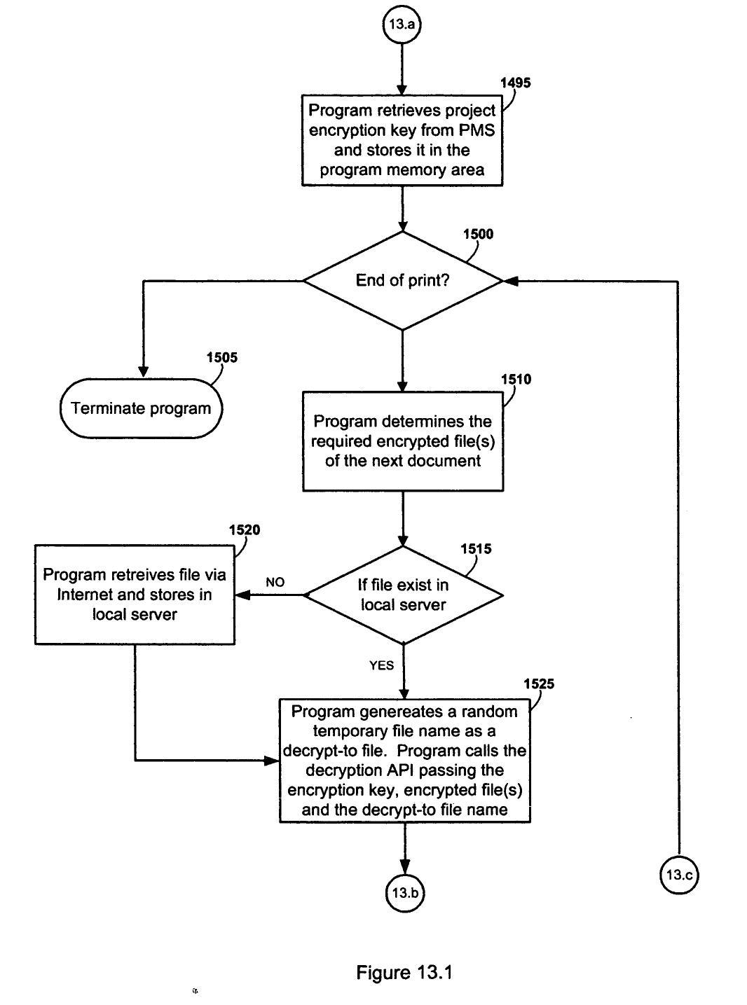

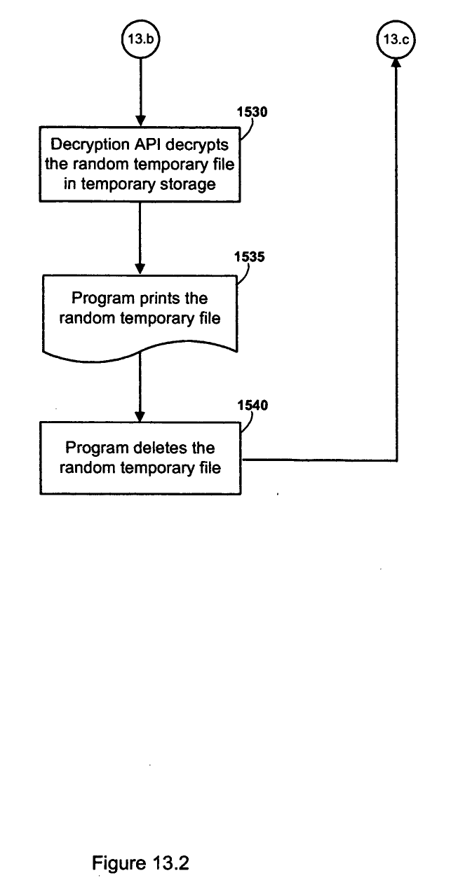

Referring to FIGS. 13, 13.1, and 13.2, there is shown a flow diagram of the print (Blowback) component of the present invention. At step 1440, a user logons to the PMS with a user ID and password or exit and proceeds to step 1445. At step 1445, if the user selects to exit, the system proceeds to step 1450 to terminate the program. At step 1445, if the user selects to login, the system proceeds to step 1460. At step 1460, if the user is not authorized, the system returns back to step 1440. At step 1460, if the user is authorized, the system proceeds to step 1465. At step 1465 the user selects a project to print or exit and the system proceeds to step 1470. At step 1470, if the user selects to exit, the system proceeds to step 1475 to terminate the program. At step 1470, if the user selects a project, the system proceeds to step 1480. At step 1480 the system verifies that the user is authorized to perform the selected project. At step 1485, if the user is not authorized, the system proceeds to step 1490 to display an error message and then returns to step 1465 to select a project to print or exit the function. At step 1485, if the user is authorized, the system proceeds to step 1495. At step 1495, the system retrieves the project encryption key and stores in the program memory area. At step 1500, the system checks for end of print status. At step 1500, if it is end of print, the system proceeds to step 1505 to terminate the program. At step 1500, if it is not end of print, the system proceeds to step 1510. At step 1510, the system determines the required encrypted files of the next document. At step 1515, the system checks if the required encrypted files exist in the local file server. If the files exist, the system proceeds to step 1525. If a file does not exist, the system proceeds to step 1520. At step 1520, the system calls the file retrieval function to retrieve the file from the web site and stores it in the local file server. The system then proceeds to step 1525. At step 1525 the system generates a random temporary file name for each required encrypted file and the system then calls the decryption API with the project encryption key, the encrypted file and the random temporary file to decrypt the document file. At step 1530, decryption API decrypts the file to the random temporary file and stores in the temporary storage. At step 1535, the system prints the decrypted random temporary file and proceeds to step 1540. At step 1540, the system deletes the decrypted random temporary file from the temporary storage and returns to step 1500 to check end of print status.

In alternative embodiments of the present invention, the system can receive a project encryption key. In this embodiment the system does not generate a project encryption key as shown in step 320 of FIG. 2, but stores the received project key within the PMS. Then, the PMS would be setup to perform the required project task.

In other alternative embodiments, the system can be provided the encryption key and the encrypted documents. In this embodiment, again the system would accept the provided encryption key. Additionally, the system would also accept and store the encrypted project documents. Then, the PMS would be setup to perform the required project tasks. Also, in this embodiment the system would not utilize the scanning or the electronic conversion component of the system. However, with this type of project, the system proceeds directly to the OCR Component, Manual Coding Component, Automatic coding component, or the documentation management component.

In other alternative embodiments, if manual coding is to be performed offsite or offshore, then the PMS administration component must setup the project tasks to be handled in that manner. In this embodiment, the encrypted project documents are stored in a local offsite or offshore file server. Then, the project path is set to the local server. The system proceeds as described above upon the completion of the transferal of the project documents to the local offsite or offshore file server. During the coding process, if a file does not exist in the local offsite or offshore file server, the coding software can retrieve the file from the web site and stores in the local offsite or offshore file server.

1. An integrated method implemented on a plurality of computer systems in a network, the method for securing and controlling access to digitized files utilized in the document management process, the method comprising:
generating a project encryption key for an identified project having a plurality of project documents to be stored and managed in a project storage area located on a computer system connected to a network;
generating a document management task plan for the identified project;
authenticating a user for the identified project based upon the task plan; for the authenticated user, controlling access to the project encryption key and the project storage area based upon the task plan;
for a selected project document by the authenticated user, generating at least one encrypted file in a specified digital format utilizing the project encryption key of the identified project;
for a selected project document by the authenticated user, generating an encrypted searchable text file from the encrypted file in a specified digital format utilizing the project encryption key of the selected document; and for a selected project document by the authenticated user, performing programmatic coding instructions based upon the task plan on the encrypted searchable text file utilizing the project encryption key of the identified project. for a selected project document by the authenticated user, performing manual coding instructions based upon the task plan on the encrypted file utilizing the project encryption key of the selected documentor the encrypted searchable file

2. The method of claim 1 wherein the step of programmatically performing coding instructions further comprises:
retrieving the project encryption key and the selected searchable encrypted text file;
using the project encryption key of the selected document, decrypting the searchable encrypted text files of the selected document into a temporary storage area;
programmatically retrieving indexing information for the selected document from the decrypted searchable text files;
storing the indexing information in the project storage area; and
deleting the decrypted searchable text file from the temporary storage area, whereby the plurality of documents of the project remain encrypted throughout the document management process.

3. The method of claim 1 wherein the plurality of project documents can be in the form of a paper product, microfilm microfiche or electronic media.

4. The method of claim 1 wherein the digital format is a graphics image format or a portable document format.

5. The method of claim 1 further comprising for a selected project document of the authenticated user, performing print instructions on the encrypted files utilizing the project encryption key.

6. The method of claim 1 wherein the step of manually performing coding further comprises:
retrieving the project encryption key and the selected project encrypted file; using the project encryption key, decrypting the selected encrypted project files into a temporary storage area;
manually retrieving the indexing information from the decrypted project files;
storing the indexing information in the project storage area; and
deleting the decrypted project files from the temporary storage area.

7. The method of claim 1 further comprising:
retrieving the project encryption key;
retrieving the selected encrypted project files;
decrypting the encrypted project files into a temporary storage area; manually performing document verification on the decrypted project files to identify errors produced during the generating step of the encrypted project file;
updating the decrypted project files of the selected document based upon the identified errors;
re-encrypting the updated decrypted project files of the selected document; and
deleting the decrypted project files of the selected document from the temporary storage area.

8. The method of claim 1 wherein the generating encrypted file step further comprises creating a job file to repetitively encrypt a group of project documents.

9. The method of claim 1 wherein the generating encrypted searchable text file step further comprises creating a job file to repetitively generate searchable text files for a group of project documents.

10. The method of claim 1 further comprising:
retrieving the project encryption key and the selected encrypted project files;
decrypting the encrypted project files into a temporary storage area;
providing tools wherein the user can perform document management functions to manipulate the decrypted project files;
if required, updating the decrypted project files based upon the document management functions;
re-encrypting the updated decrypted project files of the selected document; and
deleting the decrypted project files of the selected document from the temporary storage area.

11. The method of claim 1 wherein the step of generating a project encryption key further comprises the step of encrypting the project encryption key.

12. The method of claim 1 wherein the step of generating the at least one encrypted file further comprises:
retrieving the project encryption key; inputting the selected project document into the computer system connected to
the network;
creating an unencrypted digital image file in the specified format of the selected project document in the project storage area;
encrypting the file; and
deleting the unencrypted file.

13. The method of claim I wherein the step of generating the searchable text file further comprises:
retrieve the project key;
retrieving the encrypted file of the selected project document;
decrypting the encrypted file into the temporary storage area;
converting the decrypted file into a searchable text file;
encrypting the searchable text file;
storing the encrypted searchable text file in the project storage area; and deleting the decrypted file and unencrypted text file from the temporary storage.

14. The method of claim 4 wherein the step of generating the searchable text file in PDF further comprises:
retrieve the project encryption key;
for the selected document, retrieving the encrypted file in the portable document format (PDF);
decrypting the encrypted file in the PDF into a temporary storage area;
converting the decrypted file into searchable text file in the PDF;
encrypting the searchable text file in the PDF;
storing encrypted searchable text file in the project storage area; and
deleting the decrypted text file in the PDF from the temporary storage area;

15. The method of claims further comprising:
retrieving the project encryption key; decrypting the encrypted file of the selected project document into a temporary
storage area;
printing of the decrypted file; and deleting the decrypted project document from the temporary storage area.

16. The method of claim 6 wherein the retrieving step further comprises:
identifying whether the project storage area is remotely located on the network from the computer system of the user;
if the project storage area is remotely located, transferring the encrypted files of the selected project to a file server locally located on the network with the
computer system of the user; and
setting up the user computer system to access the encrypted files from the file server;

17. An integrated method implemented on a plurality of computer systems in a network, the method for securing and controlling access to digitized files utilized in the documentation management process, the method comprising:
receiving a project encryption key for an identified project having a plurality of project documents to be stored and managed in a project storage area located
on a computer system connected to a network;
generating a document management task plan for the identified project; authenticating a user for the identified project based upon the task plan.
for the authenticated user, controlling access to the project encryption key and the project storage area based upon the task plan;
for a selected project document by the authenticated user, generating at least one encrypted file in a specified digital format utilizing the project encryption key of the selected project;
for a selected project document by the authenticated user, generating an encrypted searchable text file from the encrypted file in a specified digital format utilizing the project encryption key of the selected document; and
for a selected project document by the authenticated user, performing manual coding instructions based upon the task plan on the encrypted file or performing programmatic coding instructions based upon the task plan on the encrypted searchable file utilizing the project encryption key of the selected document, whereby the plurality of documents of the project remain encrypted throughout the document management process.

18. An integrated method implemented on a plurality of computer systems in a network, the method for securing and controlling access to digitized files utilized in the documentation management process, the method comprising:
receiving a project encryption key for an identified project having a plurality of encrypted project documents to be stored and managed in a project storage area located on a computer system connected to a network;
generating a document management task plan for the identified project;
storage the plurality of project encrypted documents in the project storage area;
authenticating a user for the identified project;
for the authenticated user, controlling access to the project encryption key and the project storage area for the identified project;
for a selected project document by the authenticated user, performing a set of manual coding instructions based upon the task plan on the encrypted files utilizing the project encryption key of the selected document, whereby the plurality of documents of the project remain encrypted throughout the document management process.

19. An integrated method implemented on a plurality of computer systems in a network, the method for securing and controlling access to digitized files utilized in the document management process, the method comprising:
receiving a project encryption key for an identified project having a plurality of encrypted project documents to be stored and managed in a project storage area located on a computer system connected to a network;
storing the plurality of encrypted documents in the project storage area;
generating a document management task plan for the identified project;
authenticating a user for the identified project; for the authenticated user, controlling access to the project encryption key and the project storage area;
for a selected project document by the authenticated user, generating an encrypted searchable text file from the encrypted file utilizing the project encryption key for the selected project document; and
for a selected project document by the authenticated user, performing manual coding instructions based upon the task plan on the encrypted file or performing programmatic coding instructions based upon the task plan on the encrypted searchable file utilizing the project encryption key of the selected document, whereby the plurality of documents of the project remain encrypted throughout the document management process.

20. A integrated system implemented on a plurality of computer systems in a network, the method for securing and controlling access to digitized files utilized in the document management process, the system comprising:
a computer system having a project storage area, the computer system connected to the network;
an identified project having a plurality of documents to be stored in the project storage area;
a project management component operative to generate a project encryption
key and a task management plan for the identified project; an authentication component operative to authenticate a user based upon the task plan wherein the user's access to the project encryption key and the project storage area is controlled;
an encryption component operative to generate at least one of encrypted file for a selected project document in a specified digital format for an authenticated user utilizing the project encryption key;
a project generation component operative to generate searchable text files from the encrypted files in a specified digital format; and
a manual coding component operative to perform coding instructions based upon the task plan on the encrypted file for the authenticated user; and
a programmatic coding component operative to perform coding instructions based upon the task plan on the encrypted searchable text file for the authenticated user, whereby the plurality of documents of the identified project remain encrypted throughout the document management process.

21. The system of claim 1 wherein programmatic coding component is further operative to:
retrieve the project encryption key and the selected searchable encrypted text file;
using the project encryption key of the selected document, decrypt the searchable encrypted text files of the selected document into a temporary storage area;
programmatically retrieve indexing information for the selected document
from the decrypted searchable text files;
store the indexing information in the project storage area; and
delete the decrypted searchable text file from the temporary storage area, whereby the plurality of documents of the project remain encrypted throughout the document management process.

22. The system of claim 20 wherein the plurality of project documents can be in the form of a paper product, microfilm microfiche or electronic media.

23. The system of claim 20 wherein the digital format is a graphics image format or a portable document format.

24. The system of claim 20 further comprising a printing component operative for a selected project document of the authenticated user, to perform print instructions on the encrypted files utilizing the project encryption key.

25. The system of claim 20 wherein the manual coding component is further operative:
retrieve the project encryption key and the selected project encrypted file; using the project encryption key, decrypt the selected encrypted project files into a temporary storage area;
manually retrieve the indexing information from the decrypted project files;
store the indexing information in the project storage area; and
delete the decrypted project files from the temporary storage area.

26. The system of claim 20 further comprising a quality control component operative
to retrieve the project encryption key;
retrieve the selected encrypted project files;
decrypt the encrypted project files into a temporary storage area;
manually perform document verification on the decrypted project files to identify errors produced during the generating step of the encrypted project file;
update the decrypted project files of the selected document based upon the identified errors;
re-encrypt the updated decrypted project files of the selected document; and delete the decrypted project files of the selected document from the temporary storage area.

27. The system of claim 20 wherein the generating encrypted file step further comprises creating a job file to repetitively encrypt a group of project documents.

28. The system of claim 20 wherein the generation component is further operative to create a job file to repetitively generate searchable text files for a group of project documents.

29. The system of claim 20 further comprising an offsite processing component operative to:
retrieve the project encryption key and the selected encrypted project files;
decrypt the encrypted project files into a temporary storage area;
provide tools wherein the user can perform document management functions to manipulate the decrypted project files;
if required, update the decrypted project files based upon the document management functions;
re-encrypt the updated decrypted project files of the selected document; and
delete the decrypted project files of the selected document from the temporary storage area.

30. The system of claim 20 wherein the project management component is further operative to encrypt the project encryption key.

31. The system of claim 20 wherein the encryption component is further operative to:
retrieve the project encryption key;
input the selected project document into the computer system connected to the network;
create an unencrypted digital image file in the specified format of the selected project document in the project storage area;
encrypt the file; and
delete the unencrypted file.

32. The system of claim 20 wherein the generation component is further operative to:
retrieve the project encryption key;
retrieve the encrypted file of the selected project document;
decrypt the encrypted file into the temporary storage area;
convert the decrypted file into a searchable text file;
encrypt the searchable text file;
store the encrypted searchable text file in the project storage area; and delete the decrypted file and unencrypted text file from the temporary storage.

33. The system of claim 23 wherein the generation component is further operative to:
retrieve the project encryption key; for the selected document, retrieve the encrypted file in the portable document format (PDF);
decrypt the encrypted file in the PDF into a temporary storage area;
convert the decrypted file into searchable text file in the PDF;
encrypt the searchable text file in the PDF;
store encrypted searchable text file in the project storage area; and
delete the decrypted text file in the PDF from the temporary storage area;

34. The system of claim 24 wherein the printing component is further operative to:
retrieve the project encryption key;
decrypt the encrypted file of the selected project document into a temporary storage area;
print of the decrypted file; and delete the decrypted project document from the temporary storage area.

35. The system of claim 25 wherein the manual coding component further comprises a retrieval component operative to:
identify whether the project storage area is remotely located on the network from computer system of the user;
if the project storage area is remotely located, transfer the encrypted of the selected project to a file server locally located on the network with the computer system of the user, and set up the user computer system to access the encrypted files from the file server;
